(19) United States
(12) Patent Application Publication
(10) Pub. No.: US 2006/0234031 A1
(43) Pub. Date: Oct. 19, 2006

(54) Porous film, and production method and applications thereof

(75) Inventors: Atsuhiro Takata, Ichihara-shi (JP); Ryuma Kuroda, Ichihara-shi (JP); Shin-ichi Kumamoto, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/392,595

(22) Filed: Mar. 30, 2006

(30) Foreign Application Priority Data
Mar. 30, 2005 (JP) 2005-098188

(51) Int. Cl. B32B 3/26; B32B 5/22; B29C 55/00

(52) U.S. Cl. 428/304.4; 428/317.9; 264/479

(57) ABSTRACT

Disclosed is a porous film formed of a polyolefin resin comprising an ethylene-α-olefin copolymer (A) which comprises structural units originating from ethylene and structural units originating from one or more sorts of monomers selected from α-olefins having 4-8 carbon atoms and which satisfies the requirements (I) the intrinsic viscosity [η] is 9.0 to 15.0 dl/g; (II) the melting point Tm is not lower than 115° C. but lower than 130° C.; (III) the content of cold-xylene-soluble components included in the ethylene-α-olefin copolymer (A) is 3% by weight or less; and (IV) Tm≦0.54×[η]+114. A battery separator including the porous film and a method for the preparation of the porous film are also disclosed.

### BACKGROUND OF THE INVENTION

1. Technical Field

The present invention relates to porous films, layered porous films, and separators for non-aqueous batteries. Further, the present invention relates to methods for producing porous films.

2. Description of the Related Art

A separator for batteries is required to exhibit a high mechanical strength during the fabrication of a battery. It is also important for a separator to have a function to block a flow of further excessive current when an abnormal current flows in the battery due to short circuit or the like. This function is called shutdowns. As a battery separator which excels in such properties, porous films made of a high molecular weight polyethylene are under development. With recent improvement in performance of batteries, a great amount of energy has come to be stored in batteries with small volumes. Thus, strongly sought is an enhanced shutdown function, namely, an ability to lose the ion permeability (or to block an electric current) quickly at a temperature as low as possible when the temperature inside a battery exceeds a normal use temperature.

As a porous film having an enhanced shutdown function, JP 7-309965 A proposes a biaxially oriented porous film made of a copolymer of ethylene and C4-8 α-olefin having an intrinsic viscosity [η] of from 3.5 to 10.0 dl/g and having an α-olefin content of from 1.0 to 7.5 α-olefins per 1000 carbon atoms in the copolymer, wherein when this film is subjected to a melting treatment at 160° C. under restrained conditions and observed at room temperature, it comprises microfibrils in each of which structures originating from the porous structure remain.

However, the biaxially oriented porous film disclosed in Patent Document 1 is not satisfactory in both permeability at its use temperature and shutdown property at low temperatures. An object of the present invention is to provide a porous film and a layered porous film which excel in ion permeability at the use temperature and which can shutdown quickly at low temperatures if the temperature exceeds the use temperature when they are used as battery separators. Another object of the present invention is to provide a method for producing a porous film which excels in ion permeability at the use temperature and which can shutdown quickly at low temperatures if the temperature exceeds the use temperature when it is used as a battery separator. A still another object of the present invention is to provide a separator for non-aqueous batteries which excels in ion permeability at the use temperature and which can shutdown quickly at low temperatures if the temperature exceeds the use temperature.

### SUMMARY OF THE INVENTION

The present invention provides the following items or method [1] to [8]:

[1] a porous film formed of a polyolefin resin comprising an ethylene-α-olefin copolymer (A) which comprises structural units originating from ethylene and structural units originating from one or more sorts of monomers selected from α-olefins having 4-8 carbon atoms and which satisfies the requirements (I) to (IV):

(I): the intrinsic viscosity [η] is 9.0 to 15.0 dl/g;

(II) the melting point Tm is not lower than 115° C. but lower than 130° C.;

(III) the content of cold-xylene-soluble components included in the ethylene-α-olefin copolymer (A) is 3% by weight or less; and

(IV) Tm≦0.54×[η]+114.

[2] a porous film according to item [1], wherein the polyolefin resin is a polyolefin resin comprising 100 parts by weight of the ethylene-α-olefin copolymer (A) and from 5 to 100 parts by weight of a low molecular weight polyolefin (B) having a weight average molecular weight of 10000 or less,

[3] a porous film according to item [1] or [2], wherein the porous film has a pore disappearance start temperature of 110° C. or higher and a shutdown temperature of 130° C. or lower,

[4] a porous film according to any one of items [1] to [3], wherein the porous film has a air permeability of from 50 to 1000 sec/100 cc and the porous film satisfies a formula Tm+(850×d/y)<130, wherein y is the thickness (μm) of the porous film, d is the pore diameter (μm) determined by the bubble point method and Tm is the melting point ° C. of the ethylene-α-olefin copolymer (A),

[5] a porous film according to anyone of items [1] to [4], wherein the porous film has on one side or both sides thereof a heat-resistant resin layer,

[6] a porous film according to any one of items [1] to [4], wherein the porous film has on one side or both sides thereof a heat-resistant resin layer comprising a ceramic powder and a heat-resistant resin containing nitrogen element,

[7] a separator for non-aqueous batteries, the separator comprising the porous film according to any one of items [1] to [6], and

[8] a method for producing a porous film comprising the following steps (1) to (4):

(1) a step of preparing a polyolefin resin composition by kneading 100 parts by weight of (A) an ethylene-α-olefin copolymer which comprises structural units originating from ethylene and structural units originating from one or more sorts of monomers selected from α-olefins having 4-8 carbon atoms and which has an intrinsic viscosity [η] of from 9.0 to 15.0 dl/g, a melting point of not lower than 115° C. but lower than 130° C., and a content of cold-xylene-soluble components included in the ethylene-α-olefin copolymer (A) of 3% by weight or less with from 5 to 100 parts by weight (B) low-molecular-weight polyolefin having a weight-average molecular weight of 10000 or less, and from 100 to 400 parts by weight of (C) inorganic filler having an average particle diameter of 0.5 μm or less;

(2) a step of forming a sheet by use of the polyolefin resin composition,

(3) a step of removing the inorganic filler from the sheet prepared in the step (2); and

(4) a step of drawing the sheet prepared in the step (3) to form a porous film.

The porous film and separator for non-aqueous batteries according to the present invention excel in ion permeability at their use temperatures and, if the temperature exceeds their use temperatures, they can shutdown quickly at low temperatures. Further, by use of the method for producing a porous film according to the present invention, it is possible to produce a porous film which excels in ion permeability at the use temperature and which can shutdown quickly at low temperatures if the temperature exceeds the use temperature.

### BRIEF DESCRIPTION OF THE DRAWINGS

FIG. 1 is a diagram showing the results of the measurement of shutdown of the porous films produced in Examples and Comparative Examples.

FIG. 2 is a schematic diagram of an internal resistance analyzer.

In the drawings, reference numerals have the following meanings: 1: Example 1, 2: Example 2, 3: Example 3, 4: Comparative Example 1, 5: Comparative Example 2, 6: Comparative Example 3, 7: impedance analyzer, 8: separator, 9: electrolytic solution, 10: SUS plate electrode, 11: spacer made of Teflon (registered Trademark), 12; spring, 13: electrode, 14: thermocouple, and 15: data processor

### DETAILED DESCRIPTION OF THE INVENTION

The porous film of the present invention is formed of a polyolefin resin comprising an ethylene-α-olefin copolymer (A) which comprises structural units originating from ethylene and structural units originating from one or more sorts of monomers selected from α-olefins having 4-8 carbon atoms and which satisfies the requirements (I) to (IV):

(I): the intrinsic viscosity [η] is 9.0 to 15.0 dl/g;

(II) the melting point Tm is not lower than 115° C. but lower than 130° C.;

(III) the content of cold-xylene-soluble components included in the ethylene-α-olefin copolymer (A) is 3% by weight or less; and

(IV) Tm≦0.54×[η]+114

In the case where the ethylene-α-olefin copolymer (A) has an intrinsic viscosity [η] of less than 9.0 dl/g, when a porous film is used as a battery separator and the temperature inside the battery is increased abnormally, the porous film may melt to rupture and, therefore, it may fail to block an electric current. Further, the porous film will have an insufficient strength. On the other hand, an ethylene-α-olefin copolymer having an intrinsic viscosity [η] higher than 15.0 dl/g is difficult to be processed into a porous film. The intrinsic viscosity as referred to herein is a value measured in tetrahydronaphthalene (available under the tradename of Tetraline) at 135° C.

The ethylene-α-olefin copolymer (A) in the present invention has a melting point Tm of not lower than 15° C. but lower than 130° C., preferably not higher than 125° C., and more preferably not higher than 122° C. When the melting point is lower than 115° C., a battery using a porous film of the present invention as its separator will exhibit poor battery properties in a normal use temperature range. If the melting point is 130° C. or higher, the temperature at which the ion permeation is blocked, namely the shutdown temperature, will become high. It should be noted that the melting point of an ethylene-α-olefin copolymer (A) in the present invention is, unless otherwise stated, a peak top temperature of a fusion curve produced by use of a differential scanning calorimeter (DSC) according to ASTM D3417. When there are two or more peaks in the fusion curve, the temperature of the peak corresponding to the largest amount of heat of fusion ΔE: (J/g) is defined as the melting point.

The content of cold xylene soluble components (CXS) contained in the ethylene-α-olefin copolymer (A) of the present invention is 3% by weight or less, preferably 2% by weight or less, and more preferably 1.5% by weight or less. In general, the more the content of structural units originating from α-olefin in an ethylene-α-olefin copolymer, the lower the melting point of the copolymer but the more the CXS of the copolymer. In an attempt to draw a sheet prepared from a copolymer having a large CXS, the film will be resistant to be drawn. Further, when a sheet made of a copolymer having a large CXS content is drawn, a resulting drawn sheet will be low in strength. Furthermore, a porous film prepared from an ethylene-α-olefin copolymer having a large CXS content will exert a poor permeability, e.g. an air permeability of 4000 sec/100 cc or more, at its use temperature and, therefore, it is unsuitable for a separator for batteries. The content of CXS in a porous film is preferably 5% by weight or less, and more preferably 3% by weight or less. The “content of cold xylene soluble components” as referred to herein is a percentage of the weight of components soluble when 5 g of ethylene-α-olefin copolymer is dissolved in 1000 ml of xylene at 25° C. based on the original weight of the ethylene-α-olefin copolymer (i.e., 5 g).

The ethylene-α-olefin copolymer (A) used in the present invention is a polymer which satisfies a relation “Tm≦0.54×[η]+114”. In general, the higher the intrinsic viscosity [η] of the resin forming a film, the higher the strength of the film. On the other hand, the higher the intrinsic viscosity of a resin, the higher the melting point (Tm) of the resin. The present inventors had found that the melting point of a resin has an effect on the shutdown temperature of films formed of the resin. The present inventors examined many kinds of resin differing in intrinsic viscosity and melting point and, as a result, fount that use of a resin which satisfies a relation “Tm≦0.54×[η]+114” results in a porous film which exhibits a piercing strength of 300 g or more and a shutdown temperature lower than 130° C. and which is useful as a battery separator. The above relation results from the least squares approximation based on experimental results.

The ethylene-α-olefin copolymer (A) to be used in the present invention can be prepared, for example, by copolymerizing ethylene and one or more sorts of monomers selected from α-olefins having from 4 to 8 carbon atoms in the presence of a polymerization catalyst prepared by contacting an organoaluminum compound (β) with a solid catalyst component (α) with a BET method surface area of 80 m²/g or less containing a titanium atom, a magnesium atom, a halogen atom and an ester compound. Examples of the α-olefins having from 4 to 8 carbon atoms include 1-butene, 1-pentene, 4-methyl-1-pentene, 1-hexene and 1-octene. A copolymer of ethylene and an α-olefin having 9 or more carbon atoms is difficult to be extended. It, therefore, will render the production of porous films difficult. A porous film made from a copolymer of ethylene and propylene may have a higher pore disappearance start temperature.

The specific surface area, as measured by the BET method, of the solid catalyst component (α) is 80 m²/g or less, preferably from 0.05 to 50 m²/g, and more preferably from 0.1 to 30 m²/g. It is possible to achieve a small specific surface area by incorporating a sufficient amount of ester compound in the solid catalyst component (α). The content of the ester compound in the solid catalyst component (α) is preferably from 15 to 50% by weight, more preferably from 20 to 40% by weight, and even more preferably from 22 to 35% by weight, provided that the dry weight of the solid catalyst component (α) is taken as 100% by weight.

The ester compound in the solid catalyst component (ca) may be mono- or polycarboxylate, examples of which include saturated aliphatic carboxylates, unsaturated aliphatic carboxylates, alicyclic carboxylates and aromatic carboxylates. Specific examples include methyl acetate, ethyl acetate, phenyl acetate, methyl propionate, ethyl propionate, ethyl butylate, ethyl valerate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, monoethyl phthalate, dimethyl phthalate, methylethyl phthalate, diethyl phthalate, di-n-propyl phthalate, diisopropyl phthalate, di-n-butyl phthalate, diisobutyl phthalate, dipentyl phthalate, di-n-hexyl phthalate, diheptyl phthalate, di-n-octyl phthalate, di-(2-ethylhexyl) phthalate, diisodecyl phthalate, dicyclohexyl phthalate and diphenyl phthalate. From the viewpoint of polymerization activity, dialkyl phthalates are preferred. More preferred are dialkyl phthalates wherein the sum of the number of the carbon atoms in the two alkyl groups bonding to the ester bonds is 9 or more. The ester compound is typically an ester compound to be used in the preparation of the solid catalyst component (α) or an ester compound produced as a product of a reaction occurring in the preparation of the solid catalyst component (α) as mentioned below.

The content of titanium atoms in the solid catalyst component (α) is preferably from 0.6 to 1.6% by weight, and more preferably from 0.8 to 1.4% by weight, provided that the dry weight of the solid catalyst component (α) is taken as 100% by weight.

The solid catalyst component (α) may be produced by conducting the process of the preparation of a solid catalyst component disclosed in JP 11-322833 A, in the presence of an ester compound or a compound capable of generating an ester compound in the reaction system.

For example, any of the following preparation methods (1) to (5) may be used:

(1) a method in which a magnesium halide compound, a titanium compound and an ester compound are caused to contact with each other;

(2) a method in which a solution of a magnesium halide compound in alcohol is caused to contact with a titanium compound to form a solid component and then the solid component is caused to contact with an ester compound;

(3) a method in which a solution of a magnesium halide compound and a titanium compound is caused to contact with a crystallizing agent to form a solid component and then the solid component is caused to contact with a halogenated compound and an ester compound;

(4) a method in which a dialkoxy magnesium compound, a titanium halide compound an ester compound are caused to contact with each other; and

(5) a method in which a solid component including a magnesium atom, a titanium atom and a hydrocarbyloxy group, a halogenated compound and an ester compound are caused to contact with each other.

In particular, the method (5) is preferable. A method in which (a) a solid component including a magnesium atom, a titanium atom and a hydrocarbyloxy group, (b) a halogenated compound and (c) a phthalic acid derivative are caused to contact with each other is especially preferred. A more detailed description is made below.

(a) Solid Component

The solid component (a) used in the present invention is a solid component prepared by reducing a titanium compound (ii) represented by the formula [I] shown below with an organomagnesium compound (III) in the presence of an organosilicon compound (i) having an Si—O bond. Coexistence of an ester compound (iv) as an optional component may improve the polymerization activity. 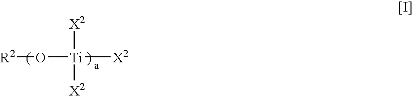
(In the formula [I], “a” represents a number of 1 to 20 and R² denotes a hydrocarbon group having from 1 to 20 carbon atoms. X² is in each occurrence a halogen atom or a hydrocarbon oxy group having from 1 to 20 carbon atoms, provided that all X²'s may be either the same or different.)

Examples of the organosilicon compound (i) having an Si—O bond are compounds represented by the following formulas:
Si(OR¹⁰)ₜR¹¹₄₋ₜ,
R¹² (R¹³₂SiO)ᵤSiR¹⁴₃, or
(R¹⁵₂SiO)ᵥ.

In the above formulas, R¹⁰ is a hydrocarbon group having from 1 to 20 carbon atoms; R¹¹, R¹², R¹³, R¹⁴ and R¹⁵ each independently represent a hydrocarbon group having from 1 to 20 carbon atoms or a hydrogen atom; t is an integer satisfying 0<t≦4; u is an integer of from 1 to 1,000; and v is an integer of from 2 to 1,000.

Specific examples of the organosilicon compound (i) are tetramethoxysilane, dimethyldimethoxysilane, tetraethoxysilane, triethoxyethylsilane, diethoxydiethylsilane, ethoxytriethylsilane, tetraisopropoxysilane, diisopropoxydiisopropylsilane, tetrapropoxysilane, dipropoxydipropylsilane, tetrabutoxysilane, dibutoxydibutylsilane, dicyclopentoxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane and phenylhydropolysiloxane. Among these organosilan compounds (i), preferred are alkoxysilane compounds represented by a formula Si(OR¹⁰)ₜR¹¹₄₋ₜ, and in that case, t is preferably an integer satisfying 1≦t≦4. A particularly preferable compound is a tetraalkoxysilane (t=4). The most preferable compound is tetraethoxysilane.

The titanium compound (ii) is a titanium compound represented by the following formula [I]: 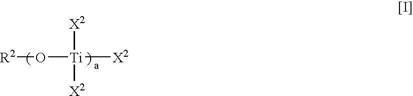
(In the formula [I], “a” represents a number of 1 to 20 and R² denotes a hydrocarbon group having from 1 to 20 carbon atoms. X² is in each occurrence a halogen atom or a hydrocarbon oxy group having from 1 to 20 carbon atoms, provided that all X²'s may be either the same or different.)

R² is a hydrocarbon group having from 1 to 20 carbon atoms. Examples of R² include alkyl groups such as a methyl group, an ethyl group, a propyl group, an isopropyl group, a butyl group, an isobutyl group, an amyl group, an isoamyl group, a hexyl group, a heptyl group, an octyl group, a decyl group and a dodecyl group; aryl groups such as a phenyl group, a cresyl group, a xylyl group and a naphthyl group; cycloalkyl groups such as a cyclohexyl group and a cyclopentyl group; allyl groups such as an propenyl group; and aralkyl groups such as a benzyl group. Among these hydrocarbon groups, preferred are alkyl groups having from 2 to 18 carbon atoms, or aryl groups having from 6 to 18 carbon atoms, and more preferred are straight-chain alkyl groups having from 2 to 18 carbon atoms.

X² is in each occurrence a halogen atom or a hydrocarbon oxy group having from 1 to 20 carbon atoms. Examples of the halogen atom as X² include a chlorine atom, a bromine atom and an iodine atom. A chlorine atom is particularly preferred. The hydrocarbon oxy groups having from 1 to 20 carbon atoms as X² are, like R², hydrocarbon oxy groups with a hydrocarbon group having from 1 to 20 carbon atoms. Particularly preferable as X² are alkoxy groups with a straight-chain alkyl group having from 2 to 18 carbon atoms.

The “a” in the titanium compound (ii) represented by the formula [I] is a number of from 1 to 20, and preferably a number satisfying 1≦a≦5.

Examples of the titanium compound (ii) include tetramethoxytitanium, tetraethoxytitanium, tetra-n-propoxytitanium, tetraisopropoxytitanium, tetra-n-butoxytitanium, tetraisobutoxytitanium, n-butoxytitaniumtrichloride, di-n-butoxytitaniumdichloride, tri-n-butoxytitanium chloride, di-n-tetraisopropylpolytitanate (mixtures of compounds having “a” of from 2 to 10), tetra-n-butylpolytitanate (mixtures of compounds having “a” of from 2 to 10), tetra-n-hexylpolytitanate (mixtures of compounds having “a” of from 2 to 10) and tetra-n-octylpolytitanate (mixtures of compounds having a of from 2 to 10). Another example is a condensate of a tetraalkoxytitanium produced by allowing a small amount of water to react with a tetralkoxytitanium.

The titanium compound (ii) is preferably a titanium compound represented by the above formula [I] wherein “a” is 1, 2 or 4. Particularly preferred is tetra-n-butoxytitanium, tetra-n-butyltitanium dimer or tetra-n-butyltitanium tetramer. The titanium compound (ii) may be used solely. Two or more sorts of titanium compounds (ii) may also be used in combination.

The organomagnesium compound (iii) may be any organomagnesium compound of an arbitrary form having a magnesium-carbon bond therein. In particular, Grignard compounds represented by a formula R¹⁶MgX⁵ wherein Mg represent a magnesium atom, R¹⁶ represents a hydrocarbon group having from 1 to 20 carbon atoms, and X⁵ represents a halogen atom, or dihydrocarbyl magnesium represented by a formula R¹⁷R¹⁸Mg wherein Mg represents a magnesium atom, R¹⁷ and R¹⁸ is each represent a hydrocarbon group having from 1 to 20 carbon atoms are preferably employed. Here, R¹⁷ and R¹⁸ may be either the same or different. Examples of each of R¹⁶ through R¹⁸ include alkyl groups, aryl groups, aralkyl groups and alkenyl groups having from 1 to 20 carbon atoms such as a methyl group, an ethyl group, a propyl group, an isopropyl group, a butyl group, a sec-butyl group, a tert-butyl group, an isoamyl group, a hexyl group, an octyl group, a 2-ethylhexyl group, a phenyl group and a benzyl group. Particularly, use of the Grignard compound represented by R¹⁶MgX⁵ in the form of an ether solution is preferred from the viewpoint of polymerization activity and stereoregularity.

For the purpose of rendering the organomagnesium compound (iii) soluble in a hydrocarbon solvent, it is permitted to use the compound in the form of a complex with another organometal compound. Examples of the organometal compound include compounds of lithium, beryllium, aluminum or zinc.

The ester compound (iv), which is an optional component, may be an ester of mono- or polycarboxylic acid and examples thereof include saturated aliphatic carboxylates, unsaturated aliphatic carboxylates, alicyclic carboxylates, and aromatic carboxylates. Specific examples thereof are methyl acetate, ethyl acetate, phenyl acetate, methyl propionate, ethyl propionate, ethyl butyrate, ethyl valerate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, monoethylphthalate, dimethylphthalate, methyl ethyl phthalate, diethyl phthalate, di-n-propyl phthalate, diisopropyl phthalate, di-n-butyl phthalate, diisobutyl phthalate, dipentyl phthalate, di-n-hexyl phthalate, di-n-heptyl phthalate, di-n-octyl phthalate, di(2-ethylhexyl) phthalate, diisodecyl phthalate, dicyclohexyl phthalate and diphenyl phthalate. Among these ester compounds, unsaturated aliphatic carboxylates such as methacrylates and maleates or aromatic carboxylates such as phthalates are preferable. In particular, dialkyl phthalates are preferably employed.

The solid component (a) is prepared by reducing a titanium compound (ii) with an organomagnesium compound (iii) in the presence of an organosilicon compound (i) or in the presince of an organosilicon compound (i) and an ester compound (iv). Specifically, a method comprising adding an organomagunesium compound (iii) to a mixture of an organosilicon compound (i), a titanium compound (ii) and, optionally, an ester compound (iv) is preferred.

It is preferable that the titanium compound (ii), the organosilicon compound (i) and the ester compound (iv) be used while being in the form of solution or slurry in an appropriate solvent. Examples of such a solvent include aliphatic hydrocarbons such as hexane, heptane, octane and decane; aromatic hydrocarbons such as toluene and xylene; alicyclic hydrocarbons such as cyclohexane, methylcyclohexane and decalin; and ether compounds such as diethyl ether, dibutyl ether, diisoamyl ether and tetrahydrofuran.

The reaction temperature of the reduction normally ranges from −50 to 70° C., preferably from −30 to 50° C., and more preferably from −25 to 35° C.

The time over which the organomagnesium (iii) is added is not particularly limited and normally from about 30 minutes to about 10 hours. The reduction proceeds in accordance with the addition of the organomagnesium (iii). After the addition, a post-reaction may be carried out at a temperature from 20 to 120° C.

The reduction reaction may be carried out in the presence of a porous carrier, such as inorganic oxide and organic polymer, which is to be impregnated with the solid component. The porous carrier may be one known in the art. Specific examples thereof include porous inorganic oxide typified by SiO₂, Al₂O₃, MgO, TiO₂ and ZrO₂; and porous organic polymer such as polystyrene, styrene-divinylbenzene copolymer, styrene-ethylene glycol-methyl dimethacrylate copolymer, poly(methyl acrylate), poly(ethyl acrylate), methyl acrylate-divinylbenzene copolymer, poly(methylmethacrylate), methylmethacrylate-divinylbenzene copolymer, polyacrylonitrile, acrylonitrile-divinylbenzene copolymer, poly(vinyl chloride), polyethylene and polypropylene. Porous organic polymers are preferably employed, and a styrene-divinylbenzene copolymer or an acrylonitrile-divinylbenzene copolymer is perticularly preferable.

From the standpoint of effective fixation of catalyst components by porous carriers, the volume of the pores having a pore radius within the range of from 20 to 200 nm is preferably from 0.3 cm³/g or more, and more preferably 0.4 cm³/g or more. The ratio of the volume of the pores having a pore radius within the aforementioned range is preferably 35% or more, and more preferably 40% or more the volume of the pores having a pore radius within the range of from 3.5 nm to 7,500 nm. Porous carriers which do not have sufficient volume of pores having a pore radius within the range of from 20 nm to 200 nm may adversely fail to fix catalyst components effectively.

The organosilicon compound (i) is used normally in an amount, in terms of the ratio of the number of silicon atoms to the number of all the titanium atoms in the titanium compound (ii), Si/Ti, ranging from 1 to 500, preferably from 1.5 to 300, and particularly preferably from 3 to 100.

The organomagnesium compound (iii) is used normally in an amount, in terms of the ratio of sum of the numbers of titanium atoms and silicon atoms to the number of magnesium atoms, (Ti+Si)/Mg, ranging from 0.1 to 10, preferably from 0.2 to 5.0, and particularly preferably from 0.5 to 2.0.

The amounts of the titanium compound (ii), the organosilicon compound (i) and the organomagnesium compound (iii) to be used are determined so that the molar ratio Mg/Ti in the solid catalyst component will fall within a range normally from 1 to 51, preferably from 2 to 31, and particularly preferably from 4 to 26.

The optional ester compound (iv) is used in an amount, in terms of the molar ratio of the ester compound to the titanium atom of the titanium compound (ii), that is, ester compound/Ti, ranging normally from 0.05 to 100, preferably from 0.1 to 60, and particularly preferably from 0.2 to 30.

The solid component prepared through reduction is normally subjected to solid-liquid separation, followed by washing with inert hydrocarbon solvent, such as hexane, heptane and toluene, repeated several times. The thus-prepared solid component (a) contains a tri-valent titanium atom, a magnesium atom and a hydrocarbyloxy group, and generally exhibits an amorphousness or a very weak crystallinity. From the viewpoint of polymerization activity and stereoregularity, it preferably has an amorphous structure.

(b) Halogen-Containing Compound

The halogen-containing compound is preferably a compound capable of causing a halogen atom to replace the hydrocarbon oxy group in the solid component (a). More preferably, it is a halogen-containing compound of an element of Group 4 in the periodic table, a halogen-containing compound of a Group 13 element or a halogen-containing compound of a Group 14 element, and even more preferably it is a halogen-containing compound (b1) of a Group 4 element or a halogen-containing compound (b2) of a Group 14 element.

As the halogen-containing compound (b1) of a Group 4 element, preferred are halogenated compounds represented by formula M¹(OR⁹)_{b}X⁴_{4-b} wherein M¹ denotes a Group 4 atom, R⁹ denotes a hydrocarbon group having from 1 to 20 carbon atoms. X⁴ denotes a halogen atom, and b is a number satisfying 0≦b<4. Examples of M¹ include a titanium atom, a zirconium atom and a hafnium atom. A titanium atom is particularly preferred. Examples of R⁹ include alkyl groups such as a methyl group, an ethyl group, a propyl group, an isopropyl group, a butyl group, an isobutyl group, a tert-butyl group, an amyl group, an isoamyl group, a tert-amyl group, a hexyl group, a heptyl group, an octyl group, a decyl group and a dodecyl group; aryl groups such as a phenyl group, a cresyl group, a xylyl group and a naphthyl group; allyl groups such as a propenyl group; and aralkyl groups such as a benzyl group. Among them, preferred are alkyl groups having 2 to 18 carbon atoms or aryl groups having 6 to 18 carbon atoms, and particularly preferred are straight-chain alkyl groups having 2 to 18 carbon atoms. Further, it is also possible to use a halogen-containing compound of a Group 4 element having two or more different OR⁹ groups.

Examples of the halogen atom represented by X⁴ include a chlorine atom, a bromine atom and an iodine atom. Among these, a chlorine atom is particularly preferred.

In the halogen-containing compounds of an element of Group 4 Represented by the formula M¹(OR⁹)_{b}X⁴_{4-b}, b is a number satisfying 0≦b<4, and preferably is a number satisfying 0≦b≦2. The most preferably, b=0. Examples of the halogen-containing compounds represented by the formula M¹(OR⁹)_{b}X⁴_{4-b} include titanium tetrahalide such as titanium tetrachloride, titanium tetrabromide and titanium tetraiodide; alkoxytitanium trihalide such as methoxytitanium trichloride, ethoxytitanium trichloride, butoxytitanium trichloride, phenoxytitanium trichloride and ethoxytitanium tribromide; dialkoxytitanium dihalide such as dimethoxytitanium dichloride, diethoxytitanium dichloride, dibutoxytitanium dichloride, diphenoxytitanium dichloride and diethoxytitanium dibromide: and also zirconium compounds and hafnium compounds corresponding thereto. Titanium tetrachloride is the most preferable.

As the halogen-containing compound of an element of Group 13 in the periodic table or a halogen-containing compound (b2) of a Group 14 element, preferred are halogenated compounds represented by formula M²R¹ₘ₋ₒX⁸_{c} wherein M² denotes a Group 13 or Group 14 atom, R¹ denotes a hydrocarbon group having from 1 to 20 carbon atoms, X⁸ denotes a halogen atom, m denotes a number corresponding to the valence of M², and c is a number satisfying 0<c≦m. Examples of the atom of Group 13 as used herein include a boron atom, an aluminum atom, a gallium atom, an indium atom and a thallium atom. A boron atom or an aluminum atom is preferred, and an aluminum atom is more preferred. Examples of the atom of Group 14 as used herein include a carbon atom, a silicon atom, a germanium atom, a tin atom and a lead atom. A silicon atom, a germanium atom or a tin atom is preferred, and a silicon atom or a lead atom is more preferred.

“m” is a number corresponding to the valence of M²; when M² is a silicon atom, m=4.

“c” is a number satisfying 0<c≦m; when M² is a silicon atom, c is preferably 3 or 4.

Examples of the halogen atom represented by X⁸ include a fluorine atoms, a chlorine atom, a bromine atom and an iodine atom. A chlorine atom is preferred.

Examples of R¹ include alkyl groups such as a methyl group, art ethyl group, a n-propyl group, an isopropyl group, a n-butyl group, an isobutyl group, an amyl group, an isoamyl group, a hexyl group, a heptyl group, an octyl group, a decyl group and a dodecyl group; aryl groups such as a phenyl group, a tolyl group, a cresyl group, a xylyl group and a naphthyl group; cycloalkyl groups such as a cyclohexyl group and a cyclopentyl group; alkenyl groups such as a propenyl group; and aralkyl groups such as a benzyl group. Alkyl groups or aryl groups are preferred, and particularly preferred is a methyl group, an ethyl group, a n-propyl group, a phenyl group or a paratolyl group.

Examples of the halogen-containing compound of Group 13 element include trichloroborane, methyldichloroborane, ethyldichloroborane, phenyldichloroborane, cyclohexyldichloroborane, dimethylchloroborane, methylethylchloroborane, trichloroaluminum, methyldichloroaluminum, ethyldichloroaluminum, phenyldichloroaluminum, cyclohexyldichloroaluminum, dimethylchloroaluminum, diethylchloroaluminum, methylethylchloroaluminum, ethylaluminum sesquichloride, gallium chloride, gallium dichloride, trichlorogallium, methyldichlorogallium, ethyldichlorogallium, phenyldichlorogallium, cyclohexyldichlorogallium, dimethylchlorogallium, methylethylchlorogallium, indium chloride, indium trichloride, methylindium dichloride, phenylindium dichloride, dimethylindium chloride, thallium chloride, thallium trichloride, methylthallium dichloride, phenylthallium dichloride and dimethylthallium chloride; and compounds having names produced by changing “chloro” in the preceding compound names to “fluoro”, “bromo” or “iodo”.

Examples of the halogen-containing compound (b2) of Group 14 element include tetrachloromethane, trichloromethane, dichloromethane, monochloromethane, 1,1,1-trichloroethane, 1,1-dichloroethane, 1,2-dichloroethane, 1,1,2,2-tetrachloroethane, tetrachlorosilane, trichlorosilane, methyltrichlorosilane, ethyltrichlorosilane, n-propyltrichlorosilane, n-butyltrichlorosilane, phenyltrichlorosilane, benzyltrichlorosilane, p-tolyltrichlorosilane, cyclohexyltrichlorosilane, dichlorosilane, methyldichlorosilane, ethyldichlorosilane, dimethyldichlorosilane, diphenyldichlorosilane, methylethyldichlorosilane, monochlorosilane, trimethylchlorosilane, triphenylchlorosilane, tetrachlorogermane, trichlorogermane, methyltrichlorogermane, ethyltrichlorogermane, phenyltrichlorogermane, dichlorogermane, dimethyldichlorogermane, diethyldichlorogermane, diphenyldichlorogermane, monochlorogermane, trimethylchlorogermane, triethylchlorogermane, tri-n-butylchlorogermane, tetrachlorotin, methyltrichlorotin, n-butyltrichlorotin, dimethyldichlorotin, di-n-butyldichlorotin, di-isobutyldichlorotin, diphenyldichlorotin, divinyldichlorotin, methyltrichlorotin phenyltrichlorotin, dichlorolead, methylchlorolead and phenylchlorolead; and compounds having names produced by changing “chloro” in the preceding compound names to “fluoro”, “bromo” or “iodo”.

From the viewpoint of polymerization activity, the halogen-containing component (b) is particularly preferably titanium tetrachloride, methyldichloroaluminum, ethyldichloroaluminum, tetrachlorosilane, phenyltrichlorosilane, methyltrichlorosilane, ethyltrichlorosilane, n-propyltrichlorosilane or tetrachlorotin.

Halogen-containing compounds (b) may be used solely. Alternatively, two or more of them may be used simultaneously or one after another.

(c) Phthalic Acid Derivative

Examples of the phthalic acid derivative (c) include compounds represented by the following formula: 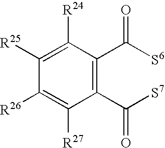
wherein R²⁴ to R²⁷ are each independently a hydrogen atom or a hydrocarbon group; S⁶ and S⁷ are each independently a halogen atom or a substituent formed by optionally combining two or more kinds of atoms selected from halogen atom, carbon atom, oxygen atom and halogen atom.

Preferred as R²⁴ to R²⁷ are a hydrogen atom and hydrocarbon groups having from 1 to 10 carbon atoms. R²⁴ to R²⁷ may optionally be linked together to form a ring structure. Preferably, S⁶ and S⁷ are each independently a chlorine atom, a hydroxyl group, or an alkoxy group having from 1 to 20 carbon atoms.

Examples of the phthalic acid derivative (c) include phthalic acid, monoethyl phthalate, dimethyl phthalate, methyl ethyl phthalate, diethyl phthalate, di-n-propyl phthalate, diisopropyl phthalate, di-n-butyl phthalate, diisobutyl phthalate, dipentyl phthalate, di-n-hexyl phthalate, di-n-heptyl phthalate, diisoheptyl phthalate, di-n-octyl phthalate, di(2-ethylhexyl) phthalate, di-n-decyl phthalate, diisodecyl phthalate, dicyclohexyl phthalate, diphenyl phthalate, phthaloyl dichloride, diethyl 3-methylphthalate, diethyl 4-methylphthalate, diethyl 3,4-dimethylphthalate, di-n-butyl 3-methylphthalate, di-n-butyl 4-methylphthalate, di-n-butyl 3,4-dimethylphthalate, diisobutyl 3-methylphthalate, diisobutyl 4-methylphthalate, diisobutyl 3,4-dimethylphthalate, di(2-ethylhexyl) 3-methylphthalate, di(2-ethylhexyl) 4-methylphthalate, di(2-ethylhexyl) 3,4-dimethylphthalate, 3-methylphthaloyl dichloride, 4-methylphthaloyl dichloride, 3,4-dimethylphthaloyl dichloride, di(2-ethylhexyl) 4-ethylphthalate and di(2-ethylhexyl) 3,4-diethylphthalate. Among them, diethyl phthalate, di-n-butyl phthalate, diisobutyl phthalate, diisoheptyl phthalate, di(2-ethylhexyl) phthalate, and diisodecyl phthalate are preferred.

When the ester contained in the solid catalyst component of the present invention is a dialkyl phthalate, it is a compound which originates from a phthalic acid derivative and has a structure of the above-shown formula in which S⁶ and S⁷ are alkoxy groups. During the preparation of the solid catalyst component, S⁶ and S⁷ of the phthalic acid derivative (c) used do not change or may be replaced by other substituents.

The solid catalyst component (α) to be used in the present invention is prepared by causing a solid component (a) prepared by reducing a titanium compound (ii) represented by formula [I] with an organomagnesium compound (iii) in the presence of an organosilicon compound (i) having an Si—O bond, a halogenated compound (b) and a phthalic acid derivative (c) to contact with each other. The contact of the components is normally carried out under an atmosphere of an inert gas such as nitrogen gas and argon gas.

Specific methods of contact treatment for producing the solid catalyst component (α) include:

a method in which (b) and (c) are added, in any order, to (a), followed by contact treatment;

a method in which (a) and (c) are added, in any order, to (b), followed by contact treatment;

a method in which (a) and (b) are added, in any order, to (c) followed by contact treatment;

a method in which (b) is added to (a), followed by contact treatment, and then (c) is further added, followed by contact treatment;

a method in which (c) is added to (a) and subjected to contact treatment, and then (b) is further added, followed by contact treatment;

a method in which (c) is added to (a) and subjected to contact treatment, and then (b) and (c) are further added in any order, followed by contact treatment:

a method in which (c) is added to (a), followed by contact treatment, and then a mixture of (b) and (c) is further added, followed by contact treatment;

a method in which (b) and (c) are added, in any order, to (a), followed by contact treatment, and then (b) is further added, followed by contact treatment; and

a method in which (b) and (c) are added, in any order, to (a) followed by contact treatment, and then a mixture of (b) and (c) is further added, followed by contact treatment.

In particular,

a method in which (b2) and (c) are added, in any order, to (a), followed by contact treatment, and then (b1) is further added, followed by contact treatment; and

a method in which (b2) and (c) are added, in any order, to (a), followed by contact treatment, and then a mixture of (b1) and (c) is further added, followed by contact treatment are more preferable. When the treatment of contact with (b1) is further repeated twice or more, the polymerization activity may be improved.

The contact treatment may be conducted by use of any known means by which the components successfully contact with each other, e.g., a slurry method and a mechanically pulverizaing method using a ball mill, for example. The mechanical pulverization, however, may result in generation of a large amount of fine powder of the solid catalyst component, broadening the particle size distribution. It, therefore, is unfavorable for practicing continuous polymerization with stability. For this reason, it is preferable to allow the components to contact with each other in the presence of solvent. Although a subsequent operation may be carried out immediately after the contact treatment, it is preferable to conducting washing treatment with a solvent in order to remove the excess substances.

It is preferable that the solvent be inert to a substance to be treated. Specific examples of the solvent include aliphatic hydrocarbons such as pentane, hexane, heptane and octanes aromatic hydrocarbons such as benzene, toluene and xylene; alicyclic hydrocarbons such as cyclohexane and cyclopentane; and halogenated hydrocarbons such as 1,2-dichloroethane and monochlorobenzene. The amount of the solvent used in the contact treatment is normally from 0.1 to 1,000 ml, and preferably from 1 to 100 ml, per gram of the solid component (a) per one step of contact treatment. A solvent is used in an amount similar to that mentioned above for one time of washing operation. The number of times of the washing operation in washing treatment is normally from 1 to 5 times for one step of the contact treatment.

The contact treatment and the washing treatment is carried out at a temperature of normally from −50 to 150° C., preferably from 0 to 140° C., and more preferably from 60 to 135° C. The contact treatment time is not particularly limited, but is preferably from 0.5 to 8 hours, and more preferably from 1 to 6 hours. The washing operation time is not particularly limited, but is preferably from 1 to 120 minutes, and more preferably from 2 to 60 minutes.

The phthalic acid derivative (c) is used in an amount of normally from 0.01 to 300 mmol, preferably from 0.05 to 50 mmol, and more preferably from 0.1 to 20 mmol, per gram of the solid component (a). If the phthalic acid derivative (c) is used too much, the particle size distribution of the solid catalyst component (α) may be broad due to the collapse of particles.

In particular, the amount of the phthalic acid derivative (c) used may be adjusted optionally so that phthalate is contained in the solid catalyst component (α) in an appropriate content. It is normally from 0.1 to 100 mmol, preferably from 0.3 to 50 mmol, and more preferably from 0.5 to 20 mmol per gram of the solid component (a). The amount of the phthalic acid derivative (c) used per mole of the magnesium atoms in the solid component (a) is normally from 0.01 to 1.0 mol, and preferably from 0.03 to 0.5 mol.

The amount of the halogen-containing compound (b) used per gram of the solid component (a) is normally from 0.5 to 1000 mmol, preferably from 1 to 200 mmol, and more preferably from 2 to 100 mmol.

When the contact treatment is carried out using each of the aforesaid compounds separately in two or more portions, the aforesaid amount of each compound used is that per one time of use of the compound.

The solid catalyst component (α) produced may be used for polymerization in the form of a slurry in combination with an inert solvent, or in the form of a fluid powder obtained by drying. The method for the drying may be, for example, a method in which volatile components are removed under reduced pressure or a method in which volatile components are removed under a flow of an inert gas such as nitrogen gas and argon gas. The drying temperature is preferably from 0 to 200° C., and more preferably from 50 to 100° C. The drying time is preferably from 0.01 to 20 hours, and more preferably from 0.5 to 10 hours. From the industrial standpoint, the weight-average particle diameter of the solid catalyst component (α) is preferably from 1 to 100 μm.

When the solid catalyst component (α) is caused to contact with an organoaluminum compound (β), a polymerization catalyst for the production of an ethylene-α-olefin copolymer (A) to be used in the present invention is produced. If needed, an electron-donating compound (γ) may be further added.

The organoaluminum compound (β) to be used in the present invention must have at least one aluminum-carbon bond in the molecule.

Typical organoaluminum compounds are represented by the formulas:
R¹⁹_{w}AlY_{3-w}
R²⁰R²¹Al—O—AlR²²R²³
wherein R¹⁹ to R²³ each independently denote a hydrocarbon group having from 1 to 20 carbon atoms; Y represents a halogen atom, a hydrogen atom or an alkoxy group; and w is an integer satisfying 2≦w≦3.

Examples of such an organoaluminum component (β) include trialkylaluminums such as triethylaluminum, triisobutylaluminum and trihexylaluminum; dialkylaluminum hydrides such as diethylaluminum hydride and diisobutylaluminum hydride; dialkylaluminum halides such as diethylaluminum chloride; mixtures of trialkylaluminums and dialkylaluminum halides such as a mixture of triethylaluminum and diethylaluminum chloride; and alkylalumoxanes such as tetraethyldialumoxane and tetrabutyldialumoxane.

Among these organoaluminum compounds, trialkylaluminums, mixtures of trialkylaluminums and dialkylaluminum halides, and alkylalumoxanes are preferred. Particularly preferred are triethylaluminum, triisobutylaluminum, a mixture of triethylaluminum and diethylaluminum chloride, and tetraethyldialumoxane.

Examples of the electron-donating component (γ) to be used for the preparation of a catalyst for olefin polymerization include oxygen-containing compounds, nitrogen-containing compounds, phosphorus-containing compounds and sulfur-containing compounds. Preferred are oxygen-containing compounds and nitrogen-containing compounds. Examples of the oxygen-containing compounds include alkoxysilicons, ethers, esters and ketones. Preferred are alkoxysilicons and ethers.

As the alkoxysilicons, alkoxysilicon compounds are used which are represented by the following formula: R³ᵣSi(OR⁴)₄₋ᵣ wherein R³ represents a hydrocarbon group having from 1 to 20 carbon atoms, a hydrogen atom or a hetero atom-containing group; R⁴ represents a hydrocarbon group having from 1 to 20 carbon atoms; r denotes an integer satisfying 0≦r<4; provided that when there are two or more R³'s and two or more R⁴'s, the R³'s or R⁴'s may be either the same or different. When the R³ is a hydrocarbon group, examples of the hydrocarbon group include straight alkyl groups such as a methyl group, an ethyl group, a propyl group, a butyl group and a pentyl group; branched alkyl groups such as an isopropyl group, a sec-butyl group, a tert-butyl group and a tert-amyl group; cycloalkyl groups such as a cyclopentyl group and a cyclohexyl group; cycloalkenyl groups such as a cyclopentenyl group; and aryl groups such as a pheny group and a tolyl group. In particular, it is preferable for a alkoxysilicon compound to have at least one R³ in which the carbon atom to which a silicon atom bonds directly is a secondary or tertiary carbon atom. When the R3 is a hetero atom-containing substituent, examples of the hetero atom include an oxygen atom, a nitrogen atom, a sulfur atom and a phosphorus atom. Specific examples include a dimethylamino group, a methylethylamino group, a diethylamino group, an ethyl-n-propylamino group, a di-n-propylamino group, a pyrrolyl group, a pyridyl group, a pyrrolidinyl group, a piperidyl group, a perhydroindolyl group, a perhydrocarbazolyl group, a perhydroacridinyl group, a furyl group, a pyranyl group, a perhydrofuryl group and a thienyl group. Preferred are substituents in which a hetero atom can form a chemical bond directly to a silicon atom of the alkoxysilicon compound.

Examples of the alkoxysilicons include diisopropyldimethoxysilane, diisobutyldimethoxysilane, di-tert-butyldimethoxysilane, tert-butylmethyldimethoxysilane, tert-butylethyldimethoxysilane, tert-butyl-n-propyldimethoxysilane, tert-butyl-n-butyldimethoxysilane, tert-amylmethyldimethoxysilane, tert-amylethyldimethoxysilane, tert-amyl-n-propyldimethoxysilane, tert-amyl-n-butyldimethoxysilane, isobutylisopropyldimethoxysilane, tert-butylisopropyldimethoxysilane, dicyclobutyldimethoxysilane, cyclobutylisopropyldimethoxysilane, cyclobutylisobutyldimethoxysilane, cyclobutyl-tert-butyldimethoxysilane, dicyclopentyldimethoxysilane, cyclopentylisopropyldimethoxysilane, cyclopentylisobutyldimethoxysilane, cyclopentyl-tert-butyldimethoxysilane, dicylohexyldimethoxysilane, cyclohexylmethyldimethoxysilane, cyclohexylethyldimethoxysilane, cycolohexylisopropyldimethoxysilane, cyclohexylisobutyldimethoxysilane, cyclohexyl-tert-butyldimethoxysilane, cyclohexylcyclopentyldimethoxysilane, cyclohexylphenyldimethoxysilane, diphenyldimethoxysilane, phenylmethyldimethoxysilane, phenylisopropyldimethoxysilane, phenylisobutyldimethoxysilane, phenyl-tert-butyldimethoxysilane, phenylcyclopentyldimethoxysilane, diisopropyldiethoxysilane, diisobutyldiethoxysilane, di-tert-butyldiethoxysilane, tert-butylmethyldiethoxysilane, tert-butylethyldiethoxysilane, tert-butyl-n-propyldiethoxysilane, tort-butyl-n-butyldiethoxysilane, tert-amylmethyldiethoxysilane, tert-amylethyldiethoxysilane, tert-amyl-n-propyldiethoxysilane, tert-amyl-n-butyldiethoxysilane, dicyclopentyldiethoxysilane, dicyclohexyldiethoxysilane, cyclohexylmethyldiethoxysilane, cyclohexylethyldiethoxysilane, diphenyldiethoxysilane, phenylmethyldiethoxysilane, 2-norbornanemethyldimethoxysilane, bis(perhydroquinolino)dimethoxysilane, bis(perhydroisoquinolino)dimethoxysilane, (perhydroquinolino)(perhydroiso quinolino)dimethoxysilane, (perhydroquinolino)methyldimethoxysilane, (perhydroisoquinolino)methyldimethoxysilane, (perhydroquinolino)ethyldimethoxysilane, (perhydroisoquinolino)ethyldimethoxysilane, (perhydroquinolino)(n-propyl)dimethoxysilane, (perhydroisoquinolino)(n-propyl)dimethoxysilane, (perhydroquinolino)(tert-butyl)dimethoxysilane and (perhydroisoquinolino)(tert-butyl)dimethoxysilane.

The ethers may be cyclic ether compounds. The cylic ether compounds are heterocyclic compounds having at least one —C—O—C— bond in the ring structure thereof. Examples of the cylic ether compounds include ethylene oxide, propylene oxide, trimethylene oxide, tetrahydrofuran, 2,5-dimethoxytetrahydrofuran, tetrahydropyrane, hexamethylene oxide, 1,3-dioxepane, 1,3-dioxane, 1,4-dioxane, 1,3-dioxolane, 2-methyl-1,3-dioxolane, 2,2-dimethyl-1,3-dioxolane, 4-methyl-1,3-dioxolane, 2,4-dimethyl-1,3-dioxolane, furan, 2,5-dimethylfuran and s-trioxane. Preferred are cyclic ether compounds having at least one —C—O—C—O—C— bonds in the ring structures thereof.

The esters include mono- or polycarboxylate, examples of which include saturated aliphatic carboxylates, unsaturated aliphatic carboxylates, alicyclic carboxylates and aromatic carboxylates. Specific examples thereof are methyl acetate, ethyl acetate, phenyl acetate, methyl propionate, ethyl propionate, ethyl butyrate, ethyl valerate, ethyl acrylate, methyl methacrylate, ethyl benzoate, butyl benzoate, methyl toluate, ethyl toluate, ethyl anisate, diethyl succinate, dibutyl succinate, diethyl malonate, dibutyl malonate, dimethyl maleate, dibutyl maleate, diethyl itaconate, dibutyl itaconate, monoethyl phthalate, dimethyl phthalate, methyl ethyl phthalate, diethyl phthalate, di-n-propyl phthalate, diisopropyl phthalate, di-n-butyl phthalate, diisobutyl phthalate, dipentyl phthalate, di-n-hexyl phthalate, di-n-heptyl phthalate, di-n-octyl phthalate, di(2-ethylhexyl) phthalate, diisodecyl phthalate, dicyclohexyl phthalate and diphenyl phthalate.

Examples of the ketones include, acetone, methyl ethyl keton, methylisobutyl ketone, ethyl butyl ketone, dihexyl ketone, acetophenone, diphenyl ketone, benzophenone and cyclohexanone.

Examples of the nitrogen-containing compounds include 2,6-substituted piperidines and 2,5-substituted piperidines such as 2,6-dimethylpiperidine and 2,2,6,6-tetramethylpiperidine; substituted methylene diamines such as N,N,N′,N′-tetramethylmethylene diamine and N,N,N′,N′-tetraethylmethylene diamine; and substituted imidazolidines such as 1,3-dibenzylimidazolidine. Preferred are 2,6-substituted piperidines.

Particularly preferable electron-donating compounds (γ) include cyclohexylmethyldimethoxysilane, cyclohexylethyldimethoxysilane, diisopropyldimethoxysilane, tert-butylethyldimethoxysilane, tort-butyl-n-propyldimethoxysilane, phenyltrimethoxysilane, diphenyldimethoxysilane, dicyclobutyldimethoxysilane, dicyclopentyldimethoxysilane, 1,3-dioxolane, 1,3-dioxane, 2,6-dimethylpiperidine and 2,2,6,6-tetramethylpiperidine.

The polymerization catalyst to be used for the present invention is produced by causing the aforesaid solid catalyst component (α), organoaluminum compound (β) and optionally electron-donating compound (γ) to contact with each other. The contact as referred to herein may be carried out by any means if the catalyst components (α), (β) and optionally (γ) can contact with each other to successfully form a catalyst. For example, a method in which the components, which have or have not be diluted with a solvent in advance, are mixed to come in contact together and a method in which the components are supplied separately to a polymerization vessel to come in contact together in the polymerization vessel may be adopted. Regarding the method of supplying the catalyst components to a polymerization vessel, it is preferable to supply them in an inert gas such as nitrogen and argon in the absence of moisture. The catalyst components may be supplied after two of them, which may be selected arbitrarily, are brought into contact with each other.

Although the polymerization to an ethylene-α-olefin copolymer (A) may be conducted in the presence of the aforesaid catalyst, it is also permitted to carry out pre-polymerization before conducting the aforementioned polymerization (main polymerization)

The pre-polymerization is normally carried out by feeding a small amount of olefin in the presence of the solid catalyst component (α) and organoaluminum compound (β), preferably in a slurry state Examples of the solvent used for forming a slurry include inert hydrocarbons such as propane, butane, isobutane, pentane, isopentane, hexane, heptane, octane, cyclohexane, benzene and toluene. In the preparation of the slurry, liquid olefin may be used in place of a part or the whole of the inert hydrocarbon.

The amount of the organoaluminum compound to be used in the pre-polymerization may be chosen widely so as to be within the range of normally from 0.5 to 700 mol, preferably from 0.8 to 500 mol, and more preferably from 1 to 200 mol per mole of titanium atoms in the solid catalyst component.

The amount of the olefin to be pre-polymerized is normally from 0.01 to 1000 g, preferably from 0.05 to 500 g, and more preferably from 0.1 to 200 g per gram of the solid catalyst component.

The slurry concentration during the pre-polymerization is preferably from 1 to 500 g-solid catalyst component/L-solvent, and more preferably from 3 to 300 g-solid catalyst component/L-solvent. The pre-polymerization temperature is preferably from −20 to 100° C., and more preferably from 0 to 80° C. The partial pressure of the olefin in the vapor phase during the pre-polymerization is preferably from 1 kPa to 2 MPa, and more preferably from 10 kPa to 1 MPa except, however, when the olefin is in a liquid state under the pressure and temperature of the pre-polymerization. The pre-polymerization time is not particularly limited, but it is normally from 2 minutes to 15 hours.

In the pre-polymerization, the solid catalyst component (α), organoaluminum compound (β) and olefin may be supplied by any method, for example, a method which comprises contacting the solid catalyst component (α) with the organoaluminum compound (β) first, followed by supplying of the olefin and a method which comprises contacting the solid catalyst component (α) with the olefin first, followed by supplying of the organoaluminum compound (β). The olefin may be supplied any method, for example, a method in which olefin is supplied successively to a polymerization vessel while the pressure in the vessel is held at a predetermined pressure and a method in which the whole of a predetermined amount of olefin is supplied at the beginning. In order for molecular weight control, a chain transfer agent, such as hydrogen, is generally added. It, however, is possible to produce an ethylene-α-olefin copolymer, which is suitable for the present invention, in the presence of a small amount of chain transfer agent like hydrogen or in the absence of chain transfer agent. Specifically, in the vapor phase above a slurry in slurry polymerization or in the vapor phase in vapor phase polymerization, the ratio of the partial pressure of hydrogen to the total of the partial pressures of hydrogen, ethylene and α-olefin is normally up to 0.10, preferably up to 0.05, and particularly preferably up to 0.02.

In pre-polymerization of a small amount of olefin on a solid catalyst component (α) in the presence of an organoaluminum compound (β), an electron-donating compound (γ) may be allowed to exist together, if necessary. The electron-donating compound used in such a manner is the whole portion or a part of the aforementioned electron-donating compound (γ). The amount of the electron-donating compound used here is normally from 0.01 to 400 mol, preferably from 0.02 to 200 mol, and particularly preferably from 0.03 to 100 mol per mole of titanium atoms contained in the solid catalyst component (α). In addition, it is normally from 0.003 to 5 mol, preferably from 0.005 to 3 mol, and particularly preferably from 0.01 to 2 mol per mole of the organoaluminum compound (β). In the pre-polymerization, the electron-donating compound (γ) may be supplied in any method. For example, it may be supplied separately from the organoaluminum compound (β) or, alternatively, it may be supplied after being brought into contact with the organoaluminum compound (β) in advance. The olefin used in the pre-polymerization may be either the same as of different from the olefin to be used in the main polymerization.

After the above-mentioned pre-polymerization or without conducting pre-polymerization, ethylene and at least one kind of monomer selected from α-olefins having from 4 to 8 carbon atoms may be copolymerized in the presence of a polymerization catalyst comprising the aforesaid solid catalyst component (α) and organoaluminum compound (β).

The amount of the organoaluminum compound for use in the main polymerization is normally within a wide range of from 1 to 1000 mol, and particularly preferably within a range of from 5 to 600 mol per mole of titanium atoms in the solid catalyst component (α). When using an electron-donating component (γ) in main polymerization, the amount of the electron-donating compound use is normally from 0.1 to 2000 mol, preferably from 0.3 to 1000 mol, and particularly preferably from 0.5 to 800 mol per mole of titanium atoms contained in the solid catalyst component (α). In addition, it is normally from 0.001 to 5 mol, preferably from 0.005 to 3 mol, and particularly preferably from 0.01 to 1 mol per mole of the organoaluminum compound.

The main polymerization may be carried out at temperatures normally within a range of from −30 to 300° C., preferably from 20 to 180° C., and more preferably from 40 to 100° C. There is no particular limitation on polymerization pressure, but from the industrial and economical standpoint, used is a pressure normally from normal pressure to 10 MPa, and preferably from 200 kPa to 5 MPa. The polymerization may be conducted either in a batch system or in a continuous system. It is also possible to impart various distributions (e.g., molecular weight distribution and comonomer composition distribution) by conducting the polymerization through a series of a plurality of polymerization steps or reactors differing in polymerization condition. Slurry polymerization or solution polymerization using an inert hydrocarbon solvent such as propane, butane, isobutane, pentane, hexane, heptane and octane may be used. In addition, bulk polymerization using, as a medium, an olefin which is in a liquid state at the polymerization temperature and vapor phase polymerization are also available.

In the main polymerization, in order to produce a polymer having a high molecular weight (i.e., a high intrinsic viscosity), it is preferable not to add a chain transfer agent such as hydrogen. The intrinsic viscosity of an ethylene-α-olefin copolymer to be produced is adjusted by adjusting the temperature and the time of the main polymerization.

The polyolefin resin which forms the porous film of the present invention preferably includes 100 parts by weight of the aforesaid ethylene-α-olefin copolymer (A) and from 5 to 100 parts by weight, more preferably from 10 to 70 parts by weight of a low molecular weight polyolefin (B) having a weight average molecular weight of 10000 or less. The polyolefin resin including the ethylene-α-olefin copolymer (A) and the low molecular weight polyolefin (B) having a weight average molecular 6 weight of 10000 or less has a favorable extendability and, therefore, is suitable for the production of a porous film by the method of the present invention as described later. The weight average molecular weight of the low molecular weight polyolefin (B) is measured by GPC (gel permeation chromatography). The contents (% by weight) of components are determined by integration of a molecular weight distribution curve produced by the GPC measurement. In many cases, the solvent used for the GPC measurement is o-dichlorobenzene and the measurement temperature is 140° C.

Specific examples of the low molecular weight polyolefin (B) for use in the present invention include polyethylene resins such as low density polyethylene, linear polyethylene (ethylene-α-olefin copolymer) and high density polyethylene; polypropylene resins such as polypropylene and ethylene-propylene copolymer; and waxes of poly(4-methylpentene-1), poly(1-butene) and ethylene-vinyl acetate copolymer. When the porous film of the present invention is used as a separator of batteries, the low molecular weight polyolefin (B) is preferably a wax which is in a solid state am 25° C. Such a low molecular weight polyolefin (B) does not have bad effects on battery properties even if it remains in a porous film.

In the present invention, the pore disappearance start temperature of a porous film is defined to be a lower one selected from a temperature at which the internal resistance reaches 100Ω and a temperature at which the resistance becomes 1/100 the maximum resistance in the internal resistance measurement using the porous film. On the other hand, the shutdown temperature is defined to be a temperature at which the internal resistance reaches 1000Ω in the internal resistance measurement. It is preferable that the porous film of the present invention have a pore disappearance start temperature of 110° C. or higher and a shutdown temperature of 130° C. or lower. Such a porous film of the present invention can ensure a preferable ion permeability at its use temperature and, when the temperature increases over the use temperature, can block an electric current quickly at a low temperature. Therefore, the porous film can be used suitably as a separator for batteries, particularly for a separator for non-aqueous batteries.

In order to block an electric current quickly at low temperature and in view of ion permeability, the air permeability of the porous film of the present invention is preferably from 50 to 1000 sec/100 cc, and more preferably from 50 to 200 sec/100 cc.

Through studies about the relation between the pore structure and the shutdown temperature of many porous films, it was found that the pore diameter and film thickness of a porous film and the melting point of the resin thereof are greatly associated with the shutdown temperature of the porous film. For example, the shutdown temperature becomes lower with reduction in pore diameter, film thickness or melting point of the resin. In the present invention, on the basis of such experimental facts, a relation between pore diameter, film thickness and melting point for rendering the shutdown temperature lower than 130° C. is established using a statistical method.

It is preferable that the thickness y (μm) of the porous film of the present invention, the pore diameter d (μm) determined by the bubble point method and the melting point Tm (° C.) of the ethylene-α-olefin copolymer (A) contained in the polyolefin resin forming the porous film satisfy the following formula: Tm+(850×d/y)<130.

A porous film satisfying the above formula excels in the electric current blocking function and it can shutdown an electric current immediately when the temperature of a battery using therein the film as a separator exceeds its use temperature.

The method for producing a porous film of the present invention is not particularly restricted. Examples of available methods include a method which comprises adding a plasticizer to a polyolefin resin, shaping the mixture into a film and removing the plasticizer with a proper solvent as disclosed in JP 7-29563 A: and a method which comprises providing a polyolefin resin film produced by a known method and forming fine pores therein by selectively drawing amorphous portions of the film which are structurally weak as disclosed in JP 7-304110 A. Wen a porous film of the present invention is formed of a polyolefin resin including an ethylene-α-olefin copolymer (A) and a low molecular weight polyolefin (B) having a weight average molecular weight of 10000 or less, it is preferable, in view of production cost, to produce the film by, for example, the following methods, that is, a method comprising;

(1) a step of kneading 100 parts by weight of an ethylene-α-olefin copolymer (A), from 5 to 100 parts by weight of a low molecular weight polyolefin (B) and from 100 to 400 parts by weight of inorganic filler (C) having an average particle diameter of 0.5 μm or less to yield a polyolefin resin composition,

(2) a step of forming a sheet by using the polyolefin resin composition,

(3) a step of drawing the sheet prepared in step (2), and

(4) a step of removing the inorganic filler (C) from the drawn sheet prepared in step (3) to form a porous film: or a method comprising:

(1) a step of kneading 100 parts by weight of an ethylene-α-olefin copolymer (A), from 5 to 100 parts by weight of a low molecular weight polyolefin (B) and from 100 to 400 parts by weight of inorganic filler (C) having an average particle diameter of 0.5 μm or less to yield a polyolefin resin composition,

(2) a step of forming a sheet by using the polyolefin resin composition,

(3) a step of removing the inorganic filler (C) from the sheet prepared in step (2), and

(4) a step of drawing the sheet prepared in step (3), which contains substantially no inorganic filler (C), to form a porous file. In view of the uniformity in thickness of a resulting porous film, it is preferable to produce a porous film by the latter method, namely, the method comprising removal of inorganic filler (C) in a sheet, followed by drawing.

In a porous film produced by removing inorganic filler (C), it is preferable that the inorganic filler (C) remain in an amount of from 100 to 20000 ppm. A porous film in which a small amount of inorganic filler remains is expected to have, when being used as a batter separator, an effect to prevent occurrence of short circuit between electrodes even if the polyolefin resin constituting the porous film melts. Moreover, the porous film in which a small amount of inorganic filler remains has a better permeability in comparison to the case of complete removal of inorganic filler. The reason for this is clear, but the remaining of a small amount of filler in the film probably renders the film resistant to be crushed along its thickness.

From the viewpoint of strength and ton permeability of porous films, the average particle size (diameter) of inorganic filler (C) to be used is preferably 0.5 μm or less, and more preferably 0.2 μm or less. The average particle size of the inorganic filler (C) in the present invention is a value determined using a SEM photograph of the inorganic filler (C). Specifically, using a scanning electron microscope (SEM), 100 particles are observed at 30000× magnification and measured for their diameters, whose average is used as an average particle diameter (μm).

Examples of the inorganic filler (C) include calcium carbonate, magnesium carbonate, barium carbonate, zinc oxide, calcium oxide, aluminum hydroxide, magnesium hydroxide, calcium hydroxide, calcium sulfate, silicic acid, zinc oxide, calcium chloride, sodium chloride and magnesium sulfate. Such inorganic filler can be removed from a sheet or film using acid or alkali solution. Because it is easy to obtain a product having a minute particle size, it is preferable to use calcium carbonate in the present invention.

The method for producing the polyolefin resin composition is not particularly restricted, but the polyolefin resin composition can be produced by mixing materials for constituting the polyolefin resin composition, such as a polyolefin resin and inorganic filler, by use of a mixing machine such as rolls, a Banbury mixer, a single screw extruder and a twin screw extruder. In the course of mixing the materials, additives, such as fatty acid esters, stabilizers, antioxidants, UV absorbers and flame retardant, may optionally be added.

The method for producing a sheet of a polyolefin resin composition for use in the present invention is not particularly restricted and it may be produced by a conventional sheet forming process, such as a tubular process, a calender process, a T-die extrusion process and a Scaife process. It is preferable to produce the sheet by the following method because a sheet with a higher accuracy in film thickness can be produced.

The preferable method for producing a sheet of a polyolefin resin composition is a method which includes pressure-extending a polyolefin resin composition using a pair of rotary forming tools whose surface temperature are adjusted to a temperature higher than the melting point of the polyolefin resin contained in the polyolefin resin composition. The surf ace temperature of the rotary forming tools is preferably higher than the melting point of the polyolefin resin by at least 5° C. The surface temperature is also preferably up to a temperature of (the melting point +30° C.), and more preferably up to a temperature of (the melting point +20° C.). Examples of the pair of rotary forming tools include rolls and belts. The peripheral speeds of the rotary forming tools are not necessarily required to be exactly the same and a difference in peripheral speed within ±5% is acceptable. When a porous film is produced by using a film prepared by the above-mentioned method, it is possible to obtain a porous film which excels in strength, ion permeability and air permeability. A laminate prepared from two or more single-layer sheets prepared by the aforementioned method may be used for the production of a porous film.

In the pressure-extension of a polyolefin resin composition using a pair of rotary forming tools, a polyolefin resin composition extruded from an extruder into a strand shape may be introduced directly to between the pair of rotary forming tools. Alternatively, a pelletized polyolefin resin composition may be used.

Drawing of a polyolefin resin composition sheet or a sheet prepared by removing an inorganic filler from the polyolefin resin composition sheet may be carried out using a tenter, rolls, an Autograph or the like. From the standpoint of air permeability, the drawing ratio is preferably from 2 to 12, and more preferably from 4 to 10. The drawing is carried out normally at a temperature not lower than the softening point of the polyolefin resin but not higher than the melting point of the resin, and more preferably at a temperature from 80 to 115° C. If the drawing temperature is too low, rupture of a film tends to occur during the drawing, whereas if the drawing temperature is too high, a resulting film may have a low air permeability or a low ion permeability. After the drawing, the drawn film is preferably subjected to heat setting. The heat setting temperature is preferably lower than the melting point of the polyolefin resin.

The present invention provides a layered porous film produced by forming a heat-resistant resin layer including a heat-resistant resin on at least one side of a porous film prepared in the method described above. The heat-resistant resin layer may be disposed on either one side or both sides of the porous film. The heat-resistant resin layer preferably include a ceramic powder. Such a layered porous film can be employed suitably as a separator for non-aqueous electrolyte solution batteries, especially, a separator for lithium ion secondary batteries due to its excellent film thickness uniformity, heat resistance, strength and air permeability (ion permeability).

The aforesaid heat-resistant resin is a polymer containing a nitrogen atom in its backbone. A heat-resistant resin having an aromatic ring is particularly preferable from the viewpoint of heat resistance. Examples thereof include aromatic polyamide, which may, hereinafter, sometimes be referred to as “aramid”, aromatic polyimide, which may, hereinafter, sometimes be referred to as “polyimide”, and aromatic polyamideimide. Examples of the aramid include meta-oriented aromatic polyamide, which may, hereinafter, sometimes be referred to as “meta-aramid”, and para-oriented aromatic polyamide, which may, hereinafter, sometimes be referred to as “para-aramid”. Para-aramid is preferable since it tends to form a porous heat-resistant resin layer excellent in film thickness uniformity and air permeability.

The para-amide is a polymer produced by polycondensation of a para-oriented aromatic diamine with a para-oriented aromatic dicarboxylic acid halide. It consists substantially essentially of repeating units in which amide bonds are linked in para-orientation or its corresponding orientation (for example, orientation extending co-axially or in parallel to reverse directions such as that in 4,4′-biphenylene, 1,5-naphthalene and 2,6-naphthalene). Specific examples thereof include para-aramids having a structure of para-orientation or orientation corresponding to para-orientation, such as poly(p-phenyleneterephthalamide), poly(p-benzamide), poly(4,4′-benzanilideterephthalamide), poly(p-phenylene-4,4′-biphenylenedicarboxylic amide), poly(p-phenylene-2,6-naphthalenedicarboxylic amide), poly(2-chloro-p-phenyleneterephthalamide), and p-phenyleneterephthalamide/2,6-dichloro p•phenyleneterephthalamide copolymer.

In the preparation of a heat-resistant resin layer, para-aramid is dissolved in a polar organic solvent and is used in the form of a coating solution. The polar organic solvent may be, but is not limited to, a polar urea-type solvent, whose specific examples include N,N-dimethylformamide, N,N-dimethylacetoamide, N-methyl-2-pyrrolidone and tetramethylurea.

From the viewpoint of coating property, the para-aramid is preferably a para-aramide having an intrinsic viscosity of from 1.0 dl/g to 2.8 dl/g, and more preferably it is one having an intrinsic viscosity of from 1.7 dl/g to 2.5 dl/g. If the intrinsic viscosity is less than 1.0 dl/g, a heat-resistant resin layer having an insufficient strength may be formed. If the intrinsic viscosity is higher than 2.8 dl/g, it may be difficult to obtain a stable para-aramid-containing coating solution. The term “intrinsic viscosity” as referred to herein is a value measured by using a solution prepared by dissolving a temporarily-crystallized para-aramid in sulfuric acid. It serves as an index of molecular weight. From the standpoint of coating property, the para-aramid concentration in the coating solution is preferably from 0.5 to 10% by weight.

In order to improve the solubility of a resulting para-aramid in a solvent, it is preferable to add a halide of alkali metal or alkaline earth metal during the polymerization for the production of aramid. Specific examples thereof include, but are not restricted to, lithium chloride and calcium chloride. The amount of the chloride added to the polymerization system is preferably within the range of from 0.5 to 6.0 mol, and more preferably from 1.0 to 4.0 mol per 1.0 mol of resulting amide groups produced throught the polycondensation. When the amount of the chloride is less than 0.5 mol, the solubility of a para-aramid produced may become insufficient, whereas addition of the chloride in an amount over 6.0 mol may be unfavorable because the amount is substantially more than the solubility of the chloride in a solvent. In general, when the amount of an alkali metal chloride or alkaline earth metal chloride is less than 2% by weight, the solubility of a para-aramid may be insufficient, whereas when over 10% by weight, an alkali metal chloride or alkaline earth metal chloride may fail to dissolve in a polar organic solvent such as a polar amide-type solvents and polar urea-type solvents.

As a polyimide to be used for the present invention, a wholly aromatic polyimide produced by polycondensation of an aromatic acid dianhydride with a diamine. Specific examples of the acid dianhydride include pyromellitic dianhydride, 3,3′,4,4′-diphenylsulfonetetracarboxylic dianhydride, 3,3′,4,4′-benzophenonetetracarboxylic dianhydride, 2,2′-bis(3,4-dicarboxyphenyl)hexafluoropropane and 3,3′,4,4′-biphenyltetracarboxylic dianhydride. Specific examples of the diamne include, but are not restricted to, oxydianiline, p-phenylenediamine, benzophenonediamine, 3,3′-methylenedianiline, 3,3′-diaminobenzophenone, 3,3′-diaminodiphenylsulfone and 1,5′-naphthalenediamine. In the present invention, polyimides soluble in a solvent may be suitably used. One example of such polyimides ia a polyimide which is a polycondensate of 3,3′,4,4′-diphenylsulfonetetracarboxylic dianhydride with an aromatic diamine. As a polar organic solvent in which a polyimide is to be dissolved, suitably used are dimethylsulfoxide, cresol, o-chlorophenol and the like as well as the solvents provided as examples of a solvent for dissolving an aramid.

The coating solution to be used for forming a heat-resistant resin layer in the present invention particularly preferably contains a ceramic powder. When a heat-resistant resin layer is formed by use of a coating solution prepared by adding a ceramic powder to a solution with an optional concentration of heat-resistant resin, it is possible to form a finely-porous heat-resistant resin layer uniform in thickness. Further, it is possible to control the air permeability by adjusting the amount of the ceramic powder to add. In view of the strength of a layered porous film and the smoothness of the surface of a heat-resistant resin layer, the ceramic powder for use in the present invention contains primary particles having an average particle diameter of preferably 1.0 μm or less, more preferably 0.5 μm or less, and even more preferably 0.1 μm or less. The average particle diameter of the primary particles is determined by a method in which an electron micrograph of the particles is analyzed using a particle size analyzer. The content of the ceramic powder in a layered porous film is preferably from 1 to 95% by weight, and more preferably from 5 to 50% by weight. If the content of the ceramic powder in a layered porous film is too small, use of the porous film as a battery separator may result in an insufficient ion permeability. If the content is too large, the film may be fragile and difficult to handle. The shape of the ceramic powder is not particularly restricted and, for example, a spherical powder and a randomly shaped powder are both available.

Examples of the ceramic powder in the present invention include ceramic powders made of electrically insulating metal oxide, metal nitride, metal carbide or the like. Specifically, powders of alumina, silica, titanium dioxide, zirconium oxide or the like are suitably employed. The ceramic powder may be used solely. Alternatively, two or more kinds of ceramic powders may be used in combination. Further, the same type or different types of ceramic powders differing in particle size may be used in combination.

The average pore size of the heat-resistant resin layer, as measured by mercury porosimetry, is preferably 3 μm or less, and more preferably 1 μm or less. If the average pore size is over 3 μm, use of such a layered porous film as a battery separator may cause problems; for example, short circuit tends to occur when a carbon powder, which is a main component of a positive or negative electrode, or a fragment thereof drops. The porosity of the heat-resistant resin layer is preferably from 30 to 80 vol %, and more preferably from 40 to 70 vol %. If the porosity is less than 30 vol %, use of such a layered porous film as a battery separator may result in a small electrolytic solution holding capacity. If it is over 80 vol %, the heat-resistant resin layer may have an insufficient strength. The thickness of the heat-resistant resin layer is preferably from 1 to 15 μm, and more preferably from 1 to 10 μm. If the heat-resistant resin layer has a thickness less than 1 μm, it may have only an insufficient effect on heat resistance. If the thickness is more than 15 μm, such a film is too thick for use as a separator for non-aqueous batteries and it may be difficult to achieve a high electric capacity.

The heat-resistant resin layer may be formed on a porous film by, for example, a method in which a heat-resistant resin layer is produced separately and then it is laminated on a porous film or a method in which a coating solution containing both a ceramic powder and a heat-resistant resin is applied to at least one side of a porous film to form a heat-resistant resin layer. In view of production efficiency, the latter method is preferred. The method in which a coating liquid containing both a ceramic powder and a heat-resistant resin is applied to at least one side of a porous film to form a heat-resistant resin layer can be achieved by a specific method including the following steps of:

(a) preparing a coating slurry liquid including a solution of 100 parts by weight of heat-resistant resin in a polar organic solvent and from 1 to 1500 parts by weight, based on 100 parts by weight of the heat-resistant resin, of a ceramic powder dispersed;

(b) applying the coating liquid to at least one side of a porous film to form a coating film; and

(c) solidifying the heat-resistant resin from the coating film by means of, for example, humidification, removal of the solvent, or immersion in a solvent which does not dissolve the heat-resistant resin, optionally followed by drying.

It is preferable to apply the coating liquid continuously by using the coating machine disclosed in JP 2001-316006 A and the method disclosed in JP 2001-23602 A.

The porous film according to the present invention are suitable as separators for non-aqueous batteries because they excel in permeability at their use temperatures and, if the temperature exceeds their use temperatures, they can shutdown quickly at low temperatures. Further, the layered porous film of the present invention excels also in heat resistance, strength, air permeability and ion permeability and, therefore, it can be employed suitably as a separator for lithium ion secondary batteries.

### EXAMPLES

(1) The Component Analysis of Solid Samples Such as Solid Catalyst Component

A titanium atom content was determined according to a method comprising decomposing about 20 mg of a solid sample in 47 mL of 0.5 mol/L sulfuric acid, adding, to the mixture, 3 mL (i.e., excess amount) of 3% by weight aqueous hydrogen peroxide solution, measuring the specific absorption at 410 nm of the resulting liquid sample by use of a double beam spectrophotometer, U-2001 manufactured by Hitachi, Ltd., and then determining the titanium atom content from a working curve separately produced. An alkoxy group content was determined as follows. About 2 g of a solid sample was decomposed in 100 mL of water. The amount of alcohol corresponding to the alkoxy groups in the resulting liquid sample was measured by internal standard gas chromatography. The amount of alcohol was converted into a content of alkoxy groups. The content of phthalate compound was determined by dissolving about 30 mg of a solid sample in 100 mL of N,N-dimethylacetamide, and measuring the amount of a phthalate compound in the solution by internal standard gas chromatography.

(2) BET Specific Surface Area

A specific surface area of a solid catalyst component was determined by the BET method on the basis of a nitrogen absorption-desorption amount using a FLOWSORB II 2300 manufactured by Micromeritics.

(3) Content of α-Olefin in Ethylene-α-Olefin Copolymer

A content of α-olefin in an ethylene-α-olefin copolymer was determined according to the method disclosed in “Polymer Analysis Handbook” (The Japan Society for Analytical Chemistry, edited by Polymer Analysis Devision). The α-olefin content was determined using a working curve on the basis of the specific absorptions of ethylene and α-olefin detected using an infrared spectrometer (1600 series, manufactured by PerkinElmer) and was indicated by the number of short chain branches per 1000 carbon atoms, i.e., SCB.

(4) Bulk Specific Gravity of Polymer Powder

A bulk specific gravity of a polymer powder was determined according to JIS K-6721 (1966).

(5) Intrinsic Viscosity [η] of Ethylene-α-Olefin Copolymer

A polymer was dissolved in tetrahydronaphthalene at 135° C. and an intrinsic viscosity was measured using an Ubbelohde's viscometer at 135° C.

(6) The Amount of CXS in Ethylene-α-Olefin Copolymer

In 1000 mL of boiling xylene, 5 g of a polymer was dissolved and then cooled in the air. The sample was allowed to stand in a thermostatic bath at 25° C. for 20 hours. Then, a polymer solidified was collected at that temperature by filtration through a filter paper (No. 50, manufactured by ADVANTEC).

The xylene in the filtrate was removed by evaporation under reduced pressure and the remaining polymer was weighed. The weight percentage of a polymer contained in 5 g of an initial polymer was determined and it was defined as CXS (unit=%).

(7) Melting Point

According to ASTM D3417, a melting point was measured using a differential scanning calorimeter (Diamond DSC manufactured by PerkinElmer). A specimen in a measuring pan was held at 150° C. for 5 minutes and then cooled from 150° C. to 20° C. at a rate of 5° C./min. After holding the sample at 20° C. for 2 minutes, the sample was heated from 20° C. to 150° C. at a rate of 5° C./min and during this process a fusion curve was produced. The peak top temperature of the fusion curve was defined as a melting point. When a fusion curve had two or more peaks, the temperature of the peak having the greatest quantity of heat of fusion, ΔH(J/g), was used as a melting point,

(8) Average Particle Diameter of Inorganic Filler

Using a scanning electron microscope (SEM) (S-4200 manufactured by Hitachi, Ltd.), 100 particles were observed at 30000× magnification and measured for their diameters, whose average was used as an average particle diameter (μm).

(9) Gurley Value

A Gurley value (sec/100 cc) of a film was measured using a B type densometer (manufactured by Toyo Seiki Seisaku-Sho Co., Ltd.) according to JIS P8117.

(10) Average Pore Diameter

An average pore diameter d (μm) of a porous film was measured by the bubble point method according to ASTM P316-86 by use of a Perm-Porometer (manufactured by PMI Co., Ltd.).

(11) Film Thickness

A film thickness was measured according to JIS K7130.

(12) Piercing Strength

A porous film was fixed with a washer having a diameter of 12 mm. A pin was pushed against the film to pierce at a rate of 200 mm/min and a maximum load (in gf (gram-force)) was measured. The maximum load was used as the piercing strength of the porous film. The pin had a diameter of 1 mm and had a tip with a curvature radius of 0.5 R.

(13) Internal Resistance

Using a cell for measuring shutdown (henceforth, referred to as a “cell”) like that shown in FIG. 2, a shutdown temperature and a pore disappearance start temperature were measured.

A square separator (8) 6 cm long in each side was placed on one SUS plate electrode (10) and was vacuum-impregnated with an electrolytic solution (9). Then, an electrode (13) to which a spring (12) was attached was put on the separator (8) so that the spring (12) stood on the electrode (13). On a spacer (11) disposed on the electrode (10), another SUS plate electrode (10) was placed and then both the electrodes (10), (10) were clamped together so that a pressure of 1 kgf/cm² was applied to the separator (8) through the spring (12) and the electrode (13). Thus, the cell was set up. As the electrolytic solution (9), used was a solution prepared by dissolving 1 mol/L of LiPFD₆ in a mixed solution composed of 30 vol % of ethylene carbonate, 35 vol % of dimethyl carbonate and 35 vol % of ethyl methyl carbonate.

Terminals of an impedance analyzer (15) were connected to both electrodes (10), (10) of the cell fabricated, and then a resistance was measured at a frequency of 1 kHz. Further, a thermocouple (14) was placed immediately below the separator so that the temperature could be measured simultaneously with the impedance. Then, a simultaneous measurement of impedance and temperature was conducted while the temperature was raised at a rate of 2° C./min. The temperature at which the impedance at 1 kHz reached 1000Ω was defined as a shutdown temperature. Further, a lower one selected from a temperature at which the impedance reached 100Ω and a temperature at which the impedance became 1/100 the maximum resistance was defined as a pore disappearance start temperature.

(14) Weight Average Molecular Weight

As a measurement apparatus, a Gel Chromatograph Alliance GEC2000 manufactured by Waters Co. was employed. The measurement conditions were as follows.

Column: TSKgel GMRHR-H(S)HT 30 cm (×2) and TSKgel GMH6-HTL 30 cm (×2), both manufactured by Tosoh Corporation.

Mobile phase: o-dichlorobenzene.

Detector: differential refractometer.

Flow rate: 1.0 mL/minute,

Column temperature: 140° C.

Injection amount: 500 μL.

After 30 mg of a sample was completely dissolved in 20 mL of o-dichlorobenzene at 145° C., the solution was filtered through a sintered filter having a pore diameter of 0.45 μm. The resulting filtrate was subjected to the measurement.

### Example 1

(1) Preparation of Solid Catalyst Component Precursor

Into a nitrogen-purged 200-L reactor equipped with a stirrer and a baffle, 80 L of hexane, 20.6 kg of tetraethoxysilane and 2.2 kg of tetrabutoxytitanium were fed and stirred. Then, to the stirred mixture, 50 L of a solution of butylmagnesium chloride in dibutyl ether (concentration: 2.1 mol/L) was dropped over 4 hours while the temperature in the reactor was kept at 5° C. After the completion of the dropping, the mixture was stirred at 5° C. for 1 hour and further at 20° C. for 1 hour, and then a solid was collected by filtration. The solid collected was washed with three portions of 70 L of toluene. Subsequently, 63 L of toluene was added to the solid to form a slurry. A part of slurry was sampled, followed by removal of solvent and drying. Thus, a solid catalyst component precursor was produced. The solid catalyst component precursor included Ti: 1.86 wt %, OEt (ethoxy group): 36.1 wt %, and OBu (butoxy group); 3.00 wt %.

(2) Preparation of Solid Catalyst Component

A 210-L reactor equipped with a stirrer was purged with nitrogen. The slurry of the solid catalyst component precursor prepared in the above (1) was fed to the reactor, followed by addition of 14.4 kg of tetrachlorosilane and 9.5 kg of di(2-ethylhexyl) phthalate. Thereafter, the mixture was stirred at 105° C. for 2 hours. The mixture was subjected to solid-liquid separation. The resulting solid was washed with three portions of 90 L of toluene at 95° C. and then 63 L of toluene was added. After heating to 70° C., 13.0 kg of TiCl₄ was added, followed by stirring at 105° C. for 2 hours. The mixture was then subjected to solid-liquid separation. The resulting solid was washed with six portions of 90 L of toluene at 95° C. and further two portions of 90 L of hexane at room temperature. After the washing, the solid was dried to yield 15.2 kg of solid catalyst component. The solid catalyst component was found to contain Ti; 0.93 wt % and di(2-ethylhexyl)phthalate: 26.8 wt %. The solid catalyst component had a specific surf ace area of 8.5 m²/g as measured by the BET method.

(3) Ethylene/Butene Slurry Polymerization

A 3-L autoclave equipped with a stirrer was thoroughly dried and then made vacuum. Subsequently, 500 g of butane and 250 g of 1-butene were placed therein and then the temperature was raised to 70° C. Successively, ethylene was introduced therein so that the partial pressure thereof became 1.0 MPa. 5.7 mmol of triethylaluminum and 10.7 mg of the solid catalyst component prepared in the above (2) were press-fed using argon to initiate polymerization. The polymerization was then continued at 70° C. for 180 minutes while continuously supplying ethylene to keep the total pressure constant.

After the completion of the polymerization reaction, the monomer unchanged was removed to yield 204 g of a polymer having a good powder property. There was almost no adhesion of the polymer to the inner wall of the autoclave and the stirrer.

The yield of the polymer per unit amount of the catalyst, namely polymerization activity, was 19100 g-polymer/g-solid catalyst component. The polymer had a bulk specific gravity of 0.38 g/mL.

(4) Production of Porous Film

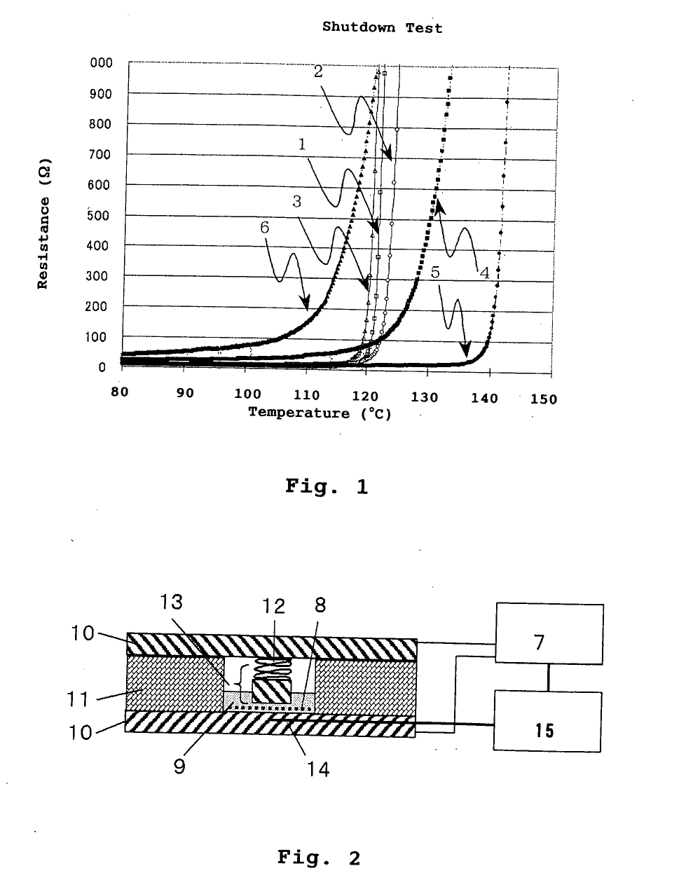

To 100 parts by weight of the ethylene-1-butene copolymer (A) prepared by the above-described method ([η]=9.1, melting point=119° C., CXS=1.02 wt %), 37.5 parts by weight of low molecular weight polyethylene (B) (weight average molecular weight=1000, Hi-wax 110P manufactured by Mitsui Chemicals, Inc.) and 175 parts by weight of calcium carbonate (C) having an average particle diameter of 0.1 μm were added to yield a mixture. To 100 parts by weight of the mixture of the (A), (B) and (C), 0.2 part by weight of a phenol-type antioxidant (IRGANOX 1010, manufactured by Ciba Specialty Chemicals) and 0.2 part by weight of a phosphorus-containing antioxidant (IRGAFOS 168, manufactured by Ciba Specialty Chemicals) were combined and then kneaded in a Laboplastmill (manufactured by Toyo Seiki Seisaku-Sho Co., Ltd.) at 210° C., a rotation speed of 150 rpm for 3 minutes. Thus, a polyolefin resin composition was produced. Subsequently, the polyolefin resin composition was extended by use of a press (at 210° C.) to yield a sheet 110 μm in thickness. The sheet was drawn to a drawing ratio of 5 at 90° C. using an Autograph. The sheet was then immersed in an aqueous acid solution (containing a surfactant) to extract calcium carbonate. The film was subsequently washed with water and then dried at 40° C. to yield a porous film. The porous film was measured for shutdown and the result is shown in FIG. 1. Further, data of the porous film including pore diameter, Gurley value, film thickness and piercing strength are shown in Table 1.

### Example 2

(1) Ethylene/Butene Slurry Polymerization

Polymerization was carried out in the same manner as Example 1(3) except using 19.3 mg of the solid catalyst component prepared in Example 1(2) and changing the polymerization temperature to 60° C. Thus, 121 g of a polymer with a good powder property was yielded.

The yield of the polymer per unit amount of the catalyst, namely polymerization activity, was 6270 g-polymer/g-solid catalyst component. The polymer had a bulk specific gravity of 0.39 g/mL.

(2) Production of Porous Film

To 100 parts by weight of the ethylene-1-butene copolymer (A) prepared by the above-described method ([η]=113.1, meltinig point=121° C., butene short chain branching degree=4.76, CXS=0.28 wt %), 37.5 parts by weight of low molecular weight polyethylene (B) (weight average molecular weight=1000, Hi-wax 110P manufactured by Mitsui Chemicals, Inc.) and 175 parts by weight of calcium carbonate (C) having an average particle diameter of 0.1 μm were added to yield a mixture. To 100 parts by weight of the mixture of the (A), (B) and (C), 0.2 part by weight of a phenol-type antioxidant (IRGANOX 1010, manufactured by Ciba Specialty Chemicals) and 0.2 part by weight of a phosphorus-containing antioxidant (IRGAFOS 168, manufactured by Ciba Specialty Chemicals) were combined and then kneaded in a Laboplastmill (manufactured by Toyo Seiki Seisaku-Sho Co., Ltd.) at 210° C., a rotation speed of 150 rpm for 3 minutes. Thus, a polyolefin resin composition was produced. Subsequently, the polyolefin resin composition was extended by use of a press (at 210° C.) to yield a sheet 112 μm in thickness. The sheet was drawn to a drawing ratio of 5 at 90° C. using an Autograph. The sheet was then immersed in an aqueous acid solution (containing a surfactant) to extract calcium carbonate. The film was subsequently washed with water and then dried at 40° C. to yield a porous film. The porous film was measured for shutdown and the result is shown in FIG. 1. Further, data of the porous film including pore diameter, Gurley value, film thickness and piercing strength are shown in Table 1.

### Example 3

(1) Ethylene/Butene Slurry Polymerization

Polymerization was carried out in the same manner au Example 1(3) except using 27.5 mg of the solid catalyst component prepared in Example 1(2) and feeding 0.57 mmol of 1,3-dioxolane before the feeding of the solid catalyst component. Thus, 275 g of a polymer with a good powder property was yielded.

The yield of the polymer per unit amount of the catalyst, namely polymerization activity, was 10000 g-polymer/g-solid catalyst component. The polymer had a bulk specific gravity of 0.42 g/mL.

(2) Production of Porous Film

To 100 parts by weight of the ethylene-1-butene copolymer (A) prepared by the above-described method ([η]=10.1, melting point=119° C., butene short chain branching degree=8.45, CXS=0.78 wt %), 37.5 parts by weight of low molecular weight polyethylene (B) (weight average molecular weight=1000, Hi-wax 110P manufactured by Mitsui Chemicals, Inc.) and 175 parts by weight of calcium carbonate (C) having an average particle diameter of 0.1 μm were added to yield a mixture. To 100 parts by weight of the mixture of the (A), (B) and (C), 0.2 part by weight of a phenol-type antioxidant (IRGANOX 1010, manufactured by Ciba Specialty Chemicals) and 0.2 part by weight of a phosphorus-containing antioxidant (IRGAFOS 168, manufactured by Ciba Specialty Chemicals) were combined and then kneaded in a Laboplastmill (manufactured by Toyo Seiki Seisaku-Sho Co., Ltd.) at 210° C., a rotation speed of 150 rpm for 3 minutes. Thus, a polyolefin resin composition was produced. Subsequently, the polyolefin resin composition was extended by use of a press (at 210° C.) to yield a sheet 150 μm in thickness. The sheet was drawn to a drawing ratio of 5 at 90° C. using an Autograph. The sheet was then immersed in an aqueous acid solution (containing a surfactant) to extract calcium carbonate. The film was subsequently washed with water and then dried at 40° C. to yield a porous film. The porous film was measured for shutdown and the result is shown in FIG. 1. Further, data of the porous film including pore diameter, Gurley value, film thickness and piercing strength are shown in Table 1.

### Comparative Example 1

To 100 parts by weight of a commercially available high molecular weight polyethylene (A) ([η]=14, melting point 136° C., HI-ZEX MILLION, manufactured by Mitsui Chemicals, Inc.), 37.5 parts by weight of low molecular weight polyethylene (B) (weight average molecular weight=1000, Hi-wax 110P manufactured by Mitsui Chemicals, Inc.) and 175 parts by weight of calcium carbonate (C) having an average particle diameter of 0.1 μm were added to yield a mixture. To 100 parts by weight of the mixture of the (A), (B) and (C), 0.2 part by weight of a phenol-type antioxidant (IRGANOX 1010, manufactured by Ciba Specialty Chemicals) and 0.2 part by weight of a phosphorus-containing antioxidant (IRGAFOS 168, manufactured by Ciba Specialty Chemicals) were combined and then kneaded in a Laboplastmill (manufactured by Toyo Seiki Seisaku-Sho Co., Ltd.) at 210° C., a rotation speed of 150 rpm for 3 minutes. Thus, a polyolefin resin composition was produced. Subsequently, the polyolefin resin composition was extended by use of a press (at 210° C.) to yield a sheet 110 μm in thickness. The sheet was drawn to a drawing ratio of 5 at 90° C. using an Autograph. The sheet was then immersed in an aqueous acid solution (containing a surfactant) to extract calcium carbonate. The film was subsequently washed with water and then dried at 40° C. to yield a porous film. The porous film was measured for shutdown and the result is shown in FIG. 1. Further, data of the porous film including pore diameter, Gurley value, film thickness and piercing strength are shown in Table 1.

### Comparative Example 2

To 100 parts by weight of a commercially available high molecular weight polyethylene (A) ([η]=14, melting point=136° C., HI-ZEX MILLION, manufactured by Mitsui Chemicals, Inc.), 37.5 parts by weight of low molecular weight polyethylene (B) (weight average molecular weight=1000, Hi-wax 110P manufactured by Mitsui Chemicals, Inc.) and 175 parts by weight of calcium carbonate (C) having an average particle diameter of 0.1 μm were added to yield a mixture. To 100 parts by weight of the mixture of the (A), (B) and (C), 0.2 part by weight of a phenol-type antioxidant (IRGANOX 1010, manufactured by Ciba Specialty Chemicals) and 0.2 part by weight of a phosphorus-containing antioxidant (IRGAFOS 168, manufactured by Ciba Specialty Chemicals) were combined and then kneaded in a twin screw kneader with a segment design capable of strong kneading (manufactured by PLABOR Co., Ltd.). Thus, a polyolefin resin composition was produced. Subsequently, the polyolefin resin composition was extended by rolling (at a roll temperature of 150° C.) to yield a sheet about 60 μm in thickness.

The resulting sheet was drawn to a drawing ratio of about 5 at a drawing temperature of 110° C. using a tenter. The sheet was then immersed in an aqueous acid solution (containing a surfactant) to extract calcium carbonate. The film was subsequently washed with water and then dried at 40° C. to yield a porous film. The porous film was measured for shutdown and the result is shown in FIG. 1. Further, data of the porous film including pore diameter, Gurley value, film thickness and piercing strength are shown in Table 1.

### Comparative Example 3

To 100 parts by weight of a commercially available high molecular weight polyethylene (A) ([η]=14, melting point=136° C., HI-ZEX MILLION 340M, manufactured by Mitsui Chemicals, Inc.), 190 parts by weight of calcium carbonate (C) having an average particle diameter of 0.1 μm, 10 parts by weight of a linear low density polyethylene (FV201 manufactured by Sumitomo Chemical Co., Ltd., melting point=120° C.) and 41 parts by weight of low molecular weight polyethylene (weight average molecular weight=1000, Hi-wax 110P manufactured by Mitsui Chemicals, Inc.) were added to yield a mixture. To 100 parts by weight of the mixture, 0.2 part by weight of a phenol-type antioxidant (IRGANOX 1010, manufactured by Ciba Specialty Chemicals) and 0.2 part by weight of a phosphorus-containing antioxidant (IRGAFOS 168, manufactured by Ciba Specialty Chemicals) were combined and then kneaded in a Laboplastmill (manufactured by Toyo Seiki Seisaku-Sho Co., Ltd.) at 210*C, a rotation speed of 150 rpm for 3 minutes. Thus, a polyolefin resin composition was produced. Subsequently, the polyolefin resin composition was extended by use of a press (at 210° C.) to yield a sheet 145 μm in thickness. The sheet was drawn to a drawing ratio of 5 at 90° C. using an Autograph. The sheet was then immersed in an aqueous acid solution (containing a surfactant) to extract calcium carbonate. The film was subsequently washed with water and then dried at 40° C. to yield a porous film. The porous film was measured for shutdown and the result is shown in FIG. 1. Further, data of the porous film including pore diameter, Gurley value, film thickness and piercing strength are shown in Table 1.

TABLE 1

| | | | | Melting | | 1000 Ω- | 100 Ω- | |
|---|---|---|---|---|---|---|---|---|
| | | | Piercing | point | Pore | reaching | reaching | |
| | Thickness y | Gurley value | strength | Tm | diameter d | point | point | Tm + 850 × d/y |
| | (μm) | (sec/100 cc) | (gf) | (° C.) | (μm) | (° C.) | (° C.) | (—) |
| Example 1 | 44 | 607 | 370 | 119 | 0.07 | 122 | 121 | 120.4 |
| Example 2 | 48 | 970 | 457 | 121 | 0.07 | 124 | 121 | 122.2 |
| Example 3 | 63 | 1000 | 480 | 119 | 0.06 | 121 | 119 | 119.8 |
| Comparative | 55 | 584 | 550 | 136 | 0.07 | 133 | 105 | 136.1 |
| Example 1 | | | | | | | | |
| Comparative | 12 | 180 | 300 | 136 | 0.08 | 138 | 123 | 140.7 |
| Example 2 | | | | | | | | |
| Comparative | 62 | 400 | 641 | 136 | 0.09 | 121 | 137 | 136.2 |
| Example 3 | | | | | | | | |

1. A porous film formed of a polyolefin resin comprising an ethylene-α-olefin copolymer (A) which comprises structural units originating from ethylene and structural units originating from one or more sorts of monomers selected from α-olefins having 4-8 carbon atoms and which satisfies the requirements (I) to (IV):
(I): the intrinsic viscosity [η] is 9.0 to 15.0 dl/g;
(II) the melting point Tm is not lower than 115° C. but lower than 130° C.;
(III) the content of cold-xylene-soluble components included in the ethylene-α-olefin copolymer (A) is 3% by weight or less; and
(IV) Tm≦0.54×[η]+114.

2. The porous film according to claim 1, wherein the polyolefin resin is a polyolefin resin comprising 100 parts by weight of the ethylene-α-olefin copolymer (A) and from 5 to 100 parts by weight of a low molecular weight polyolefin (B) having a weight average molecular weight of 10000 or less.

3. The porous film according to claim 1, wherein the porous film has a pore disappearance start temperature of 110° C. or higher and a shutdown temperature of 130° C. or lower.

4. A porous film according to claim 1, wherein the porous film has an air permeability of from 50 to 1000 sec/100 cc and the porous film satisfies a formula Tm+(850×d/y)<130, wherein y is the thickness (μm) of the porous film, d is the pore diameter (μm) determined by the bubble point method and Tm is the melting point ° C. of the ethylene-α-olefin copolymer (A).

5. The porous film according to claim 1, wherein the porous film has on one side or both sides thereof a heat-resistant resin layer.

6. The porous film according to claim 1, wherein the porous film has on one side or both sides thereof a heat-resistant resin layer comprising a ceramic powder and a heat-resistant resin containing nitrogen element.

7. A separator for non-aqueous batteries, the separator comprising the porous film according to claim 1.

8. A method for producing a porous film comprising the following steps (1) to (4):
(1) a step of preparing a polyolefin resin composition by kneading 100 parts by weight of (A) an ethylene-α-olefin copolymer which comprises structural units originating from ethylene and structural units originating from one or more sorts of monomers selected from α-olefins having 4-8 carbon atoms and which has an intrinsic viscosity [η] of from 9.0 to 15.0 dl/g, a melting point of not lower than 115° C. but lower than 130° C., and a content of cold-xylene-soluble components included in the ethylene-α-olefin copolymer (A) of 3% by weight or less, with from 5 to 100 parts by weight (B) low-molecular-weight polyolefin having a weight-average molecular weight of 10000 or less, and from 100 to 400 parts by weight of (C) inorganic filler having an average particle diameter of 0.5 μm or less;
(2) a step of forming a sheet by use of the polyolefin resin composition;
(3) a step of removing the inorganic filler from the sheet prepared in the step (2); and
(4) a step of drawing the sheet prepared in the step (3) to form a porous film.
